(19) United States
(12) Patent Application Publication
(10) Pub. No.: US 2010/0088246 A1
(43) Pub. Date: Apr. 8, 2010

(54) SYSTEM FOR, AND METHOD OF, MANAGING A SOCIAL NETWORK

(76) Inventor: Michael Z. Lim, Playa Del Rey, CA (US)

Correspondence Address: FULWIDER PATTON LLP, HOWARD HUGHES CENTER, 6060 CENTER DRIVE, TENTH FLOOR, LOS ANGELES, CA, 90045, US

(21) Appl. No.: 12/244,579

(22) Filed: Oct. 2, 2008

(51) Int. Cl. G06Q 30/00; G06F 15/16; G06F 7/06; G06F 17/30

(52) U.S. Cl. 705/319; 705/26; 709/203; 707/E17.014; 705/14.4

(57) ABSTRACT

A system for, and method of, managing multiple communications between a plurality of users in a social network wherein a first user sends a request to initiate a communication exchange with a second user. The system restricts the maximum number of pending unanswered requests by a user. The system encourages selectivity in solicitation.

### FIELD OF THE INVENTION

The field of the invention is generally related to online social networks and dating websites. In particular, the invention relates to a system for, and method of, managing interactions between a plurality of users in a social network.

### GENERAL BACKGROUND AND STATE OF THE ART

For years people have preferred meeting new people through social networks because it provides a safe and comfortable environment for interacting with strangers, and it increases the possibility of meeting others with desired qualities through a larger forum. In recent years online social networks have become a useful way to meet new people as an alternative to more traditional methods of introductions, such as in person introduction at church, in a bar, a park, or during public functions. Online social networks increase the range of desirable candidates by connecting people, sometimes instantaneously, across multiple cities, countries, regions, or even globally. Those attempting to make new friends or find a potential romantic relationship can do so from the comfort of their own home, without the fear of face-to-face rejection.

There are several online “dating” websites in existence (Match.com, eHarmony.com, etc.), and several patents have issued for such systems (U.S. Pat. No. 7,188,153 to Lunt, et al.; U.S. Pat. No. 5,950,200 to Sudai, et al.; U.S. Pat. No. 5,963,951 to Collins; U.S. Pat. No. 6,052,122 to Sutcliffe, et al.; U.S. Pat. No. 6,061,681 to Collins; U.S. Pat. No. 7,069,308 to Abrams; U.S. Pat. No. 6,073,105 to Sutcliffe, et al.). Other online services offer forums for communication between communities of users through message boards and/or chat rooms. These types of services allow mass publication of “online profiles” to the general public or a large association of subscribers.

One popular goal of a person joining an online social network is to meet people with desirable qualities. Most online social networks attempt to meet this goal by allowing members to post an online profile, accessible publicly or by selected members, to attract other members. Contact between members may be initiated by some form of solicitation from one member to another, either by email, instant messaging, a blog, or forum posting.

On eHarmony.com a member can only solicit other members that the system itself deems a match. Before any actual dialogue can occur between those matched the members must open up communication and exchange sets of pre-selected/pre-composed questions over several rounds. During this stage, or even once email communication is established, a member can choose to end all communications. Only after this ‘courting’ has been completed may the users freely email each-other. A member is restricted from searching for other potential matches except those that the system derives. This type of service frustrates those who want a greater participation in the selection process.

On Match.com and other dating websites, a member, for a monthly fee, can solicit any number of other members simultaneously, not just those that the system matches. A member does not have to worry about rejection and therefore may freely solicit as many other members as it deems necessary to achieve a return reply. The member can send out solicitations even if it is obvious that the other members solicited would not be interested—perhaps because the soliciting member does not possess the qualities desired or there is a clear disparity in the physical appearance between the solicitor and the member solicited. Further exacerbating the situation, such systems frequently incorporate a “wink” method for quick introductions without the need for writing an individualized email to each person solicited.

A large amount of users coupled with the ability for any single user to instantly send tens if not hundreds of solicitations in a single session creates an environment in which users become overwhelmed with writing or receiving correspondence. While more attractive users are often inundated with unwanted solicitations, the response rate for the majority of others can be low. This only encourages these users to send a large volume of solicitations to achieve a reasonable response rate, and further discourages users from composing time consuming emails, opting instead for a quick introduction, or “wink”. As more members opt to use quick introduction techniques the disparity in response rate grows even further, and the need for the typical user to send even more solicitations is perpetuated.

Due to the increased time burden of reading other member's profiles, composing a meaningful solicitation, and pressure to obtain a reasonable response rate, the focus becomes less on what actual qualities the person solicited desires and more on physical attributes. This results in those members who are physically attractive to receive even a greater majority of correspondence, regardless if it was obvious at the outset there is no potential for a match. The response rate for typical members with an average physical appearance is diminished as more solicitations are routed to the more attractive despite whether the corresponding profiles clearly show similar interests, education, or parity of physical qualities.

For the more attractive members there is an overwhelming time burden of sifting through tens if not hundreds of undesirable solicitations, repeat solicitations from already rejected candidates, and, in some cases, solicitations that are merely made for the purpose of causing aggravation or even harassment. For the typical member there is an increased pressure to obtain a reasonable response rate, encouraging the use of mass solicitations without the effort of meaningful research into the personal qualities of those solicited. The typical member is ultimately forced to send bulk solicitations and later sort out and categorize only those that respond. Lastly, the system itself becomes strained as the online traffic increases with each new member and as each existing member becomes encouraged to use mass solicitation. The company hosting the social network is forced to purchase supplementary high end equipment and reoccurring software license fees to meet the increasing traffic demand.

Additionally, the ability to quickly send correspondence to thousands of members discourages traditional use of handwritten letters or emailed correspondence. This so called “date spamming” tends to focus on appearance at the expense of similar intellectual or social qualities, and ultimately leads to unreasonable expectations. There is often a false impression that every member is available for a date, when many members are, in fact, unavailable for a myriad of reasons. If date spamming could be reduced it would compel more reasonable expectations.

Members of online social networks also frequently fail to respond to solicitations for extended lengths of time because they may be too busy to answer, there are too many solicitations to read within one sitting, or they are on vacation or out-of-town for an extended period. Many members also simply choose to ignore solicitations at their leisure, choosing to respond only when the more favorable solicitations have been dealt with or have proven to be unsuccessful. Uncertainty in the overall social network is fostered as delayed responses create the perception that members are not sincere about making new connections in the social network or simply not fully participating in the process.

Many online social networks have attempted to limit mass solicitation by allowing a member to hide his or her profile from all other members. Consequently, this restricts the hidden member from developing any solicitation or response from any members who would have desirable qualities. The member must unhide his or her profile to regenerate interest. Many members attempt to avoid this deficiency by posting a profile without a picture. However, a profile without a picture is frowned upon and will receive little if any solicitations. An attractive member must then choose between receiving little to no solicitations or an overwhelming amount, depending on whether a picture is posted.

The concept of searching for a date for a specific event is another goal of social network users. In the past, when a person needed to find accompaniment for a particular event he or she would rely on friends and family to find an available date. And so, the “blind date” has been a popular method of choice in traditional social networks. Nevertheless, the blind date does not account for the “personal choice” offered by online social networks. Online social networks, however, are ill-equipped to introduce people quickly when it comes to finding a date for pre-planned events. Additionally, more and more people are looking for dates spur-of-the-moment, usually in their immediate surroundings. Even with the advent of GPS devices there is currently no way to pair socially compatible persons instantly who may be near to each other yet on-the-move and away from a wired computer system. A date seeker must go home and logon to a social dating system and run searches and or instant message persons through the system. There is a need for these persons to use a system to instantly find not only a desirable match who is compatible in similar likes and interests but someone who is also immediately available and desirably near in geographic proximity.

Cultural practices are also important in building relationships and in the courtship of a potential spouse, mate, or partner. Gift giving has been a common and even expected part of courtship in many cultures. Giving a gift prior to, or upon a first date, is looked on as favorable in many cultures and even mandatory in others. At this time, online dating networks provide no way for giving a physical gift.

It can be seen, then, that there is a need for a system for, and method of, managing multiple communications between a plurality of users in a social network. Specifically, there is a need for an online social network that can reduce the amount of solicitations between members such that (1) more traditional communication is encouraged, (2) unrealizable expectations are limited, and (3) valuable resources by reducing online traffic and strain on the online systems are preserved, and (4) selectivity in solicitation and responses is encouraged. There is also a need for an online social network that (5) encourages prompt response time, (6) provides for a way to find others for accompaniment on a specific day, time or event, and/or instantaneously by present geographic location, (7) provides a way for a solicited person who is busy but interested to delay a communication without discouragement to the solicitor, (8) allows members to block undesirable candidates on an individual basis so that potential communication with other potential matches is not diminished, (9) provides for cultural practices such as gift giving, and (10) provides a rating system for members' responsiveness. The system may not, and need not, satisfy every need yet still be effective. In fact, various embodiments only satisfy a portion of the listed needs and each need is not a requirement of an effective system. Furthermore, other embodiments fulfill additional needs.

### SUMMARY OF THE INVENTION

A first embodiment of the present invention includes a computerized system for managing communications between a plurality of users in a social network. The social network typically comprises a database that stores at least a unique identifier for each of the plurality of users, and a server computer, wherein the server is programmed to receive from a first user a request to initiate a communication exchange with a second user, forward the request to the second user, while maintaining a programmable setting for restricting a maximum number of pending unanswered requests by a user, and a programmable setting for canceling the request if the second user does not reply within a predetermined time.

The server may be additionally programmed to allow a communication connection between the first user and the second user if the second user accepts the request. The server may also be programmed to store connection information when the second user replies to the request, the connection information being at least the unique identifier of the first user and the unique identifier of the second user. A number of completed communication connections for each of the plurality of users, and/or an availability schedule for each of the plurality of users may also be stored.

The server may also have a programmable setting for disabling the communication exchange if the second user does not communicate with the first user within a second predetermined time, and may be further programmed to store in the database an availability schedule for each of the plurality of users to limit communications between any of the plurality of users and at least one other user based on the availability schedule of the users.

The server may also be programmed to receive characteristic data and contact information from at least one of the plurality of users, to receive criteria data from a first user, to allow the plurality of users to selectively hide a portion of the characteristic data or contact information from a selected subset of all users in the social network, wherein the selected subset of all users includes at least one other user, to present to the first user non-hidden characteristic data for each user in a subset of the plurality of users, wherein the subset of the plurality of users is determined by the criteria data received from the first user, and wherein the second user is selected from the subset of the plurality of users.

The server may further be programmed to limit communications in the social network to users in a common geographic location, the common location region being determined by a region associated with a specific geographic location of respective GPS-enabled devices, the respective GPS-enabled devices being associated with the users. The region can be user-configurable to a state, city, or radius surrounding the specific geographic location; and, the predetermined time may be set by the second user prior to the request being made by the first user.

The server may also be further programmed to display a list of physical gifts to the first user, and enable the first user to select from the list a selected physical gift to be sent to the second user, enable the first user to initiate a purchase of the selected physical gift, enable the second user to accept to receive the selected physical gift at a true physical address of the second user before the first user is charged a fee and before the gift is purchased or sent to the second user, and after the second user has accepted the gift, send purchase information for the selected physical gift and the true physical address of the second user to a vendor responsible for selling the selected physical gift.

The server may further be programmed to charge the first and second user a first fee when the communication exchange is allowed. The system may be programmed to withhold an amount equal to the first fee from the first and second user when the request is made and returned if request is cancelled so that the first and second user cannot establish a second communication without paying a second fee until the first fee is returned. In effect, the fee is held in escrow by the social-network site until the request is cancelled (at which point the fee is returned) or until the request is accepted (at which point the fee is charged). Consequently, if a user wants to make another communication exchange while the fee is in escrow then another fee must be paid. The server can also be programmed to charge the first fee only from the first user or to charge only the second user.

The server may further be programmed to calculate and display a ratio of total number of requests received to a total number of cancelled requests for each of the plurality of users; and/or to store in the database a total number of times a communication connection was established and a total number of times an actual communication did not occur; and/or to calculate and display a ratio of total number of accepted requests to a total number of accepted requests in which a communication did not occur within a second predetermined time for each of the plurality of users.

In a second embodiment, the present invention includes a method of managing multiple communications between a plurality of users in a social network comprising receiving from a first user a request to initiate a communication exchange with a second user in the social network, tallying a total number of pending unanswered requests by the first user, verifying the total number of pending unanswered requests is less than a predetermined number, and displaying to a second user a request to initiate a communication exchange from a first user, wherein the request is displayed only if a number of pending unanswered requests by the first user is less than a predetermined number. The display of the request may further require a number of pending unanswered requests by the second user to be less than a second predetermined number. The request may be cancelled if the second user does not answer within a predetermined time, and the communication exchange allowed if the second user accepts the request within the predetermined time. The second user may be allowed to answer by postponing communication with the first user. The communication may be disabled if the first and second users do not communicate within a second predetermined time.

In one aspect of the second embodiment, the method further comprises a step of storing characteristic data and contact information for each of the plurality of users, wherein the contact data includes a true physical address, and wherein a portion of the characteristic data or contact information may be selectively hidden from a selected subset of all users in the social network, and wherein the selected subset of all users includes at least one other user. Criteria data is received from the first user and the first user presented non-hidden characteristic data for each user in a subset of the plurality of users, the subset of the plurality of users being determined by the criteria data received from the first user, wherein the second user is selected from the subset of the plurality of users. The subset of the plurality of users may be further determined by an availability schedule selected by each of the plurality of users.

In another aspect the method includes presenting to the first user characteristic data for each user in a subset of the plurality of users, wherein the subset of the plurality of users is limited to geographically selected users having a common geographic location with the first user, the common geographic location being determined by a region associated with a specific geographic location of respective GPS-enabled devices, the respective GPS-enabled devices being associated with the first and the geographically selected users, and wherein the second user is selected from the subset of the plurality of users. The region may be user-configurable to a state, city, or radius surrounding the geographic location, and the predetermined time may be set by the first user prior to the subset being determined.

In yet another aspect the method includes storing characteristic data for each of the plurality of users, wherein the characteristic data includes a ratio of total number of accepted requests to a total number of accepted requests in which a communication did not occur within a second predetermined time, and may further include storing characteristic data for each of the plurality of users, wherein the characteristic data includes a ratio of total number of requests received to a total number of cancelled requests.

In a further aspect the method includes the social network enabling the second user to receive a gift from the first user, wherein the gift is not received unless accepted by the second user. In this aspect, the first user selects from a list a selected physical gift to be sent to the second user, the social network enables the first user to purchase the selected physical gift, the second user agrees to receive the selected physical gift at a true physical address of the second user before the first user is charged a fee and before the gift is purchased or sent to the second user, the social network forwards purchase information for the selected physical gift and the true physical address of the second user to a vendor responsible for selling the selected physical gift, the account of the first user is charged, and the gift is sent to the true physical address of the second user. In this aspect, the true physical address is typically not revealed to the first user.

In yet a further aspect the method further comprises enabling the first user to purchase an advertisement to be displayed as part of the characteristic data of the second user, wherein the advertisement is displayed to the second user when the second user uses the social network.

In a third embodiment, the method includes a first user selecting a first membership level, wherein a first communication fee is associated with the first membership level. A second user also selects a second membership level, wherein a second communication fee is associated with the second membership level. The system receives from the first user a request to initiate a communication exchange with the second user in the social network, and selects a selected fee, wherein the selected fee is the highest of the first and second communication fees, and wherein the selected fee is set as the cost of a completed communication exchange. The system tallies a total amount of selected fees for pending unanswered requests by the first user, and verifies the total amount of selected fees is less than an amount in an account of the first user. The request to initiate the communication exchange is displayed to the second user only if the total amount of selected fees for pending unanswered requests by the first user is less than the amount in the account of the first user.

In one aspect of the third embodiment, displaying the request further requires a total amount of selected fees for unanswered requests by the second user to be less than an amount in an account of the second user. The method may further comprise the steps of canceling the request if the second user does not answer within a predetermined time, and allowing the communication exchange if the second user accepts the request within the predetermined time. In this aspect the first and second user are charged the selected fee when the communication exchange is allowed. In another aspect, an amount equal to the selected fee is withheld from the first and second user when the request is made and returned if request is cancelled.

In a fourth embodiment, the present invention is a method of generating revenue from a plurality of users in an online social network comprising the steps of establishing a communication connection between a first and a second user when the second user accepts a request to initiate a communication exchange by the first user, and charging the first and second user a first fee for each communication exchange.

In one aspect of the fourth embodiment, an amount equal to the first fee is withheld from the first and second user when the request is made and returned if the request is not accepted within a predetermined time so that the first and second user cannot establish a second communication exchange without paying a second fee until the first fee is returned. In effect, the fee is held in escrow during the predetermined time and if a user wants to make another communication exchange while the fee is in escrow then another fee must be paid. In another aspect the first fee is charged only from the first user. In another aspect the first fee is charged only from the second user. The first and second fees may each comprise at least one token, wherein a user can purchase a number of tokens for a third fee. The method may further be modified such that either the first user or the second user can pay the first fee for the other user, wherein the other user is notified prior to accepting the communication exchange that the first or second user will pay for the communication exchange.

In another aspect of the fourth embodiment, the first fee is increased proportional to a selected membership level, the selected membership level being selected from the highest of a first membership level selected by the first user and a second membership level selected by the second user, and wherein the first and second membership levels are selected prior to establishing the communication exchange. In yet another aspect, the cost of the completed communication exchange is set by the first membership level, wherein the first user selects a membership level prior to the second user accepting the request to initiate the communication exchange. In yet another aspect, the cost of the completed communication exchange is set by the second membership level, wherein the second user selects a membership level prior to the request to initiate the communication exchange.

Other features and advantages are inherent in the system and methods claimed and disclosed or will become apparent to those skilled in the art from the following detailed description and its accompanying designs.

### BRIEF DESCRIPTION OF THE DRAWINGS

A detailed description of the embodiment of the invention will be made with reference to the accompanying drawings:

FIG. 1 is a system diagram of a first embodiment of the present invention;

FIG. 2 is a website map, showing a visual representation of an embodiment of a system for, and method of, managing multiple communications between a plurality of users in a social network, the embodiment being a website;

FIG. 3 is a flow chart illustrating an exemplary set of steps for storing characteristic data for a user;

FIG. 4 is a data diagram illustrating the relationship between data information for typical user in an embodiment of the present invention;

FIG. 5 is an example of a screen shot of a member profile;

FIGS. 6A and 6B are flow charts illustrating an exemplary set of steps for search for other members within the system;

FIG. 7 is a flow chart illustrating an exemplary set of methods to be performed by one user upon the profile of another user;

FIGS. 8A-8F are flow charts illustrating an exemplary set of methods for hiding and unhiding all or some of a user's characteristic data;

FIG. 9 is an example of a member home page that manages contacts and communications for a member;

FIG. 10 a flow chart illustrating an exemplary set of methods for managing contacts and communications for a member;

FIG. 11 a flow chart illustrating an exemplary set of methods for timing out a communication;

FIG. 12 is a flow chart illustrating an exemplary set of methods for sending a gift to another member; and

FIG. 13 is a flow chart illustrating a method for sending a token to another user to pay for the receiving member's acceptance.

### DETAILED DESCRIPTION OF THE PREFERRED EMBODIMENTS

In the following description of preferred embodiments, reference is made to the accompanying drawings that form a part hereof, and in which is shown by way of illustration specific embodiments in which the invention may be practiced. It is to be understood that other embodiments may be utilized without departing from the scope of the present invention.

The present detailed description is for the purpose of convenience only and is not intended to limit the present invention. Accordingly, the invention will be described with respect to online dating website systems that use internet network architecture and infrastructure. It is to be understood that the particular network architecture described also applies to other social network systems using other computer network architectures, including wired and wireless networks. The invention employs typical email and instant messaging systems within internet network and other computer network architectures, and includes desktop and laptop computers, smart-mobile phones, PDAs, or any other devices with internet capability.

In order to describe the preferred embodiments of the present invention, a dictionary of terms is helpful to understand certain terms used. This dictionary of terms is directed to a dating site, however, it is not limited to just a dating site, but applicable to any social network. The terms used are defined as follows:

Member: A user who has joined the social network

Request: A requesting member's initiation of an interaction or communication with another member. Also called “date request” or “goose request.” It is the general objective of the embodiments that the number of pending active requests be restricted to a limited number (e.g. to a maximum of 3 requests at a time).

Requester: A user who requests a contact or date (“Goose” request), a communication, or some other initial contact through the social network. The term “requester” may be used synonymously with the term “sending user”.

Recipient: A user who receives a request. The term “recipient” may be used synonymously with the term “receiving user”.

Goose (request accepted): An acceptance response given by a recipient that opens up communication (e.g. email, IM) with the requester. For purposes of this disclosure, the term “goose” refers to the action of asking another person to join in contact or accept the request to join in contact.

Duck (request deferred): A recipient denies immediate contact, but allows for future contact requests (I'm not available right now but you may ask again later).

Autoduck (request deferred): The default response when the recipient does not respond before a contact request (goose request) is timed out. The Autoduck response functions in the same way as a Duck response.

Block (requester): A recipient denies contact and blocks future contact requests, and furthermore, in some embodiments, the requester can no longer see the recipient profile (unless removed from block list later). In other embodiments, any member can block any other member.

Token: A symbolic unit of payment, an actual monetary value, credit, or some other division or representation thereof paid by either the requester or the recipient or both (depending on the situation) once a request is accepted by the recipient (Goose). Tokens may also be used for paying for sent gifts or advertisements.

Nest Egg: Typically, a token provided by the requester to the recipient in order to make an acceptance free for the recipient. Conversely, the recipient may offer up a Nest Egg to any potential requester such that if the recipient accepts a Goose request offer, the request is free for the requester.

Goose List (accepted contacts): A list maintained by each user of requesters and recipients that the user has established contact with

Watch List: A list maintained by each user of other users that he/she is interested in establishing contacts in the future. The list is also updated with the users' availability with data from their Dating Calendar and their incoming Goose requests availability. For example, the list may show a user as actively seeking a new contact if their Dating Calendar indicates an availability in the near predetermined future (e.g. within 1 month) and it will also show if that member is available for goosing if he/she has a number of incoming Goose requests less than an allowed maximum.

Duck List (deferred contacts): A list maintained by each user of requesters and recipients who have deferred contacts (i.e. a list of other users who have either (a) ducked the user's request, or (b) have been ducked by the user)

Block List (blocked contacts): A list maintained by each user of other members who have been blocked by the user and who will no longer see the user's profile

Virtual Flowers: A gift of flowers that appears as an icon on a recipient's site pages (all pages viewed by the recipient containing the Flower Carousel) and can be accompanied with a thumbnail picture of the user who sent the flowers. The sender of the virtual flowers must purchase the gift with tokens and he/she can only send the flowers to users on his/her Goose List. However, the sender will not be charged for the virtual flowers until the recipient accepts the gift.

Flower Carousel: A banner that appears on designated pages that a user visits on the site. The banner is a rotating gallery of pictures of other users who sent virtual flowers. When a user purchases virtual flowers (e.g. 3 tokens for purchase) and sends them to another user, the recipient can either accept or reject. If the virtual flowers are rejected, the gifting user gets back his/her tokens (full refund). If the virtual flowers are accepted then the recipient agrees to have the sender's picture rotate through the Flower Carousel for a period of time (e.g. 1 week). In another embodiment, the Flower Carousel can be named “Top Goose.”

Timer: An icon clock that winds down as a contact request (goose request) times out.

Token bank: An icon displaying the number of tokens that a user has remaining in his/her account. In an embodiment it is clickable in order to allow the user to buy more tokens.

Token escrow: Holds the tokens that a user uses for contacts or gift purchases (e.g. goose request, nest egg purchase, or virtual flowers purchase) until the recipient user accepts the contact or the gift. If the recipient user rejects contact or the gift, the token goes back into the user's token bank. The token escrow may appear as an icon similar to the token bank icon.

Dating Calendar: A calendar on a user's profile showing the dates when the user is available to go on a physical date. Additionally, the calendar may contain information about a particular activity that the user is interested in doing on a date (e.g. a concert or a ski trip). Mousing over a day on a user's Dating Calendar can show the information about the desired activity on that date. Free days on the calendar may be shown in green, whereas free days with desired activities may show up as yellow. In one embodiment, the Dating Calendar is used for informational purposes when a user is evaluating whether or not to make a contact request based on the recipient's Dating Calendar. In another embodiment, the Dating Calendar may be used as a scheduling system, where a user can request a contact (goose request) tied to a specific date based on the information displayed on the recipient's Dating Calendar. In another embodiment, when a recipient accepts a date on a particular day, that day is designated as unavailable on the Dating Calendar. In another embodiment, the Dating Calendar can be named Availability Schedule.

Instant-Date: A Dating Calendar designation of a day where the recipient will be available and that if the recipient accepts a contact request (goose request) tied to the Instant-Date, he/she agrees to go out with the requester on that date if he/she accepts the request. The Instant-Date may show information such as desired activities/events. The instant-date concept also applies to the ability to instantaneously search for and find someone who is not only a desirable match and who is compatible in similar likes and interests, but finding someone who is immediately available and desirably near in geographic proximity. In an embodiment of the present invention respective GPS-enabled devices are integrated with the system and used to achieve this objective.

In an embodiment of the invention, the Dating Calendars of users are searchable. This permits a search for users that are available on particular dates, for particular activities, and/or for Instant-Dates.

Ratings: The invention can provide for user ratings. For example, there can be two types of automatic ratings. Ratings may be based on the users' activities for the past 30 days.

Autoduck rating: The response rate calculated as the percentage of unanswered contact requests received (timed out goose request) by a user. The Autoduck rating provides an indication of how responsive a user is to contact requests. If a user has a high Autoduck rating then, it may indicate that the user may 1) be unavailable 2) is not serious about establishing contacts 3) is not responsible 4) is currently in a relationship or 5) is not an active user on the site. The Autoduck rating provides a user with information as to whether or not the user should use a resource (limited goose request) to request a contact with the recipient. In another embodiment, the Autoduck Rating ratio calculation can be inverted and named Response Rating, where a high Response Rating is equivalent to a low Autoduck rating.

Wild Goose Chase rating: The percentage of times the user has failed to initiate a communication after an established contact within a limited time (e.g. a user accepted a goose and then failed to communicate (e.g. email, IM) within one week). The Wild Goose Chase rating provides an indication of how responsive a user is after a contact request has been accepted (goose). If a user has a high Wild Goose Chase rating, it may indicate that the user may 1) be on the site to simply get attention 2) is not sincere or responsible or 3) is too busy and is not responsive in dating. The Wild Goose Chase rating informs a user about whether sending a contact request is a good idea. In another embodiment, the Wild Goose Chase Rating ratio calculation can be inverted and named Sincerity Rating, where a high Sincerity Rating is equivalent to a low Wild Goose Chase Rating.

The preceding terms are used for convenience of exemplary discussion only and are not to be understood as limiting the invention.

Messaging tools, such as an instant messenger, email, telephone, webcam, or combination of functions, can be incorporated into the site and accessed throughout the user pages.

This embodiment of the invention has the following set of rules:

Each requester can only have a limited number (e.g. 3) of open contact requests (goose requests) at a time. Each contact request times out after a fixed period of time (e.g. 24 hours). A recipient must give a response (goose, duck, or block) to a contact request within a fixed period of time (e.g. 24 hours) otherwise it becomes an Autoduck.

Requesters must present a token (a unit of payment) when they make a contact request.

If the recipient accepts a contact request, then both the requester and the recipient are charged one token.

Requesters can provide the recipient with a nest egg (a gift of 1 token) to be used if the request is accepted. If the request is rejected, requester gets both tokens back (1 for nest egg and 1 for contact request).

Users can only communicate (e.g. email, IM) with other users who are on their goose list.

These embodiments of the invention have the following innovations:

1. Users can only request a limited number (e.g. 3) of contact requests (goose requests) at one time. This minimizes date spamming and places a value on contact requests as a limited resource that encourages users to carefully evaluate (e.g. compatibility, availability, and/or rating) their contact requests.

2. The timer concept associated with Autoduck and Wild Goose Chase ratings encourages prompt responses. The Autoduck rating encourages the recipient to promptly respond to a contact request (goose request) and the Wild Goose Chase rating encourages the users to initiate communication in a timely fashion after contact has been established (goose acceptance).

3. The system charges users only for the goose contacts they establish. Most existing dating sites charge a monthly usership fee with the idea that users' dating possibilities are unlimited. The concept of charging a user only if he/she finds a date is hard to implement if the site allows users to communicate (e.g. email, IM) freely. The innovative charging method of the present invention (charging per established contact) helps to ensure that, 1) a requester will likely not make a contact request (goose request) unless he/she is really interested in meeting the recipient because the requester has a cost associated with the request acceptance (e.g. 1 token charge to the requester for recipient's acceptance) 2) a recipient will likely not accept a contact request (goose request) unless he/she is really interested in meeting the requester because the recipient also has a cost associated with the request acceptance (e.g. 1 token charge to the recipient for the request acceptance unless they receive a ‘Nest Egg’ from the requester 3) users can't communicate (e.g. email, IM) with each other until a contact is established (goose request is accepted)—this ensures that the operator of the social network gets paid.

4. The Token Escrow—this unique feature of the site provides that a user can purchase a gift for another or make a contact request but will not be charged until the recipient user accepts the gift or contact request. The token escrow gives a mechanism to lock up the requesting/gifting user's tokens (units of payment) while waiting for an accept/reject answer from the recipient user. The escrow insures confidence for a requesting/gifting user that his/her money is not being wasted on a useless gift or contact. A user only pays if a contact request or a gift is accepted.

5. The concept that users cannot communicate (e.g. email, IM) with each other until a contact has been established—a requester requests a goose and the recipient responds with a goose. This is a useful feature because the requester no longer needs to waste time writing an introductory email unless he/she knows that the recipient is interested in a contact. This feature works in conjunction with Innovation 1 (see above)—which limits a requester from sending numerous requests—the practice of Date Spamming . A ‘wink’ system exists on current dating sites where the requester can send a generic ‘hi’ or a ‘wink’ as a first contact instead of composing an email. This is highly looked down upon because the recipient may feel that the requester is not sincere and is just sending a generic request (Date Spamming). A requester may be discouraged from sending a time consuming email as the response rate on these sites can be low due to date spamming and a lack of date availability information (a user maybe currently dating someone or may be busy too to establish a new contact). On eHarmony.com, communication is restricted by forcing users exchange sets of pre-selected/pre-composed questions over several rounds of exchanges until they are allow to freely email each other. These question exchanges can be tedious and time consuming; whereas, the innovation of the present invention's one-click request/acceptance of a contact request is much more streamlined and unproblematic. Moreover, the problem of date spamming is addressed by limited the number of communication requests.

6. The ability to duck (postpone response) a contact request. This innovation allows the recipient to tell the requester that, “I am interested in talking to you but I am currently busy right now—try again later”. A user on existing dating sites may not answer a contact request because he/she is seeing someone else or is busy—the duck gives a good alternative response, “I'm saving you for later just in case.” The duck also encourages the requester to keep an eye on the recipient's availability schedule, so that he/she may try contacting the recipient again at a later opportune time (e.g. the recipient's Dating Calendar shows a free day or an Instant-Date). Likewise, a recipient who has ducked a requester can find him/her in his/her duck list and try contacting the requester back at a later date. Furthermore, since the recipient responded earlier with a polite duck, it is much more socially acceptable for him/her to request a contact with the requester at a later date.

7. The ability to block one or more users. When a recipient blocks a requester, the requester will no longer be able to see the recipient's profile until the recipient unblocks the requester. This allows a user to get rid of unwanted solicitations. Other dating sites permit an all-or-nothing blocking of communications (e.g. email, IM) and do not limit access to portions of users' profiles. The block feature of the present invention can ensure complete privacy, but, more importantly, it allows a user to block a portion of his/her profile (e.g. the Dating Calendar) from another user to achieve partial privacy. This is a useful feature because, for example, if a user is not fully committed to another user during the dating process, he/she may block the Dating Calendar in his/her profile from the other user in order to obtain greater discretion in seeking other dating opportunities. Moreover, a user can single out other users, or groups of users, to block. This innovation also allows a user to block others from appearing in future searches. This is a useful filtering feature for users who are searching through the available user roster—users do not waste time evaluating users that they have blocked already. Unlike eHarmony and other websites, the present invention allows a user to search and date anyone in the system and the block feature also allows you to block any or all other undesirable users. This block system does not exist on similar sites such as eHarmony and Match.com that force a user to block all or no users at once.

8. The concept of an automated and quantifiable Autoduck rating—informs the requester of the odds of receiving a response from the recipient. The Autoduck rating provides an indication of how responsive a user is to contact requests. If a user has a high Autoduck rating then, it may indicate that the user may 1) be unavailable 2) is not serious about establishing contacts 3) is not responsible 4) is currently in a relationship or 5) is not an active user on the site. This is useful because a user can only request a limited number of contact requests (e.g. 3 goose request) at a time and requests don't time out (Autoduck) for a period (e.g. 24 hours). Consequently, a user's resources (available requests) are tied up and there is an impetuous to be selective in making the contact request.

9. The concept of an automated and quantifiable Wild Goose Chase rating provides an indication of how responsive a user is after a contact request has been accepted (goose). If a user has a high Wild Goose Chase rating, it may indicate that the user may 1) be on the site to simply get attention 2) is not sincere or responsible or 3) is too busy and is not responsive in dating. The Wild Goose Chase rating informs a user about whether sending a contact request is a good idea.

10. In one embodiment, users can only receive a limited number (e.g. 10) of contact requests (goose requests) at one time. This encourages recipients of contact requests to reply expeditiously because they are not able to receive any other contact requests until they have responded to at least one of the pending contact requests. (The requester is informed at the time of goosing that the recipient has a full request inbox.) The recipients are incentivized to respond expeditiously because they may be missing out on higher quality contact requests. A full contact request inbox of a recipient may also indicate the potential requester that the recipient is extremely popular and that his/her efforts may be more beneficially directed elsewhere.

11. The concept of the sending a ‘Nest Egg’ along with a contact request allows a requester to differentiate his/herself from other requesters. It allows the requester to display generosity and interest at the critical stage of introduction in the courting process by offering to pay the cost of acceptance for the recipient. Alternatively, the recipient may offer up a Nest Egg to any potential requester such that if the recipient accepts a Goose request offer, the request is free for the requester. This displays generosity to all potential requesters by saying “if you goose me, and I goose you back, your cost of goosing me is free.”

12. Dating Calendar—users can indicate in advance what days they are available to go on a date for some time period (e.g. up to 4 weeks in advance). The Dating Calendar provides useful information for a user deciding on who to send a contact request to (goose request)—if a user is busy or is seeing someone else, he/she will likely not indicate availability on the Dating Calendar. Also, users can search for other users based upon availability, interested dating activities/events, or Instant-Dates on their Dating Calendar.

13. The ability of a user to indicate a predefined Instant-Date on a Dating Calendar (e.g. I want to go to a U2 concert on this day, I'm in town this Saturday evening and I want to go out and party, or I want to be taken out this Friday night) as oppose to free days. The Instant-Date can be distinguished from other free days on the calendar such as by color coding. When a requester sees just a regular free day, he/she might request a contact with the recipient with the intent of establishing communication that may follow up as a physical date soon after. Whereas, when a requester sees an Instant-date, he/she can directly request for the Instant-Date through a contact request tied to the Instant-Date. This has two advantages: 1) it allows a recipient looking for a date/activity partner to distinguish himself/herself by guaranteeing a physical date if he/she accepts a contact request tied to the Instant-Date—hence increasing his/her probability of receiving contact requests 2) it allows for requesters to search for users wanting to go out on a physical date on a specific day and are not only readily available but are guaranteeing a physical date should they accept the contact request. The instant-date concept also applies to the ability to instantaneously search for and find someone who is not only a desirable match and who is compatible in similar likes and interests, but also to find someone who is immediately available and desirably close in geographic location. In an embodiment of the present invention respective GPS-enabled devices are integrated with the system and used to achieve this objective. A date seeker can now find a date while on-the-move and without having to go home and logon to a social dating system.

14. Virtual Banner—A banner (e.g. Flower Carousal) that appears on designated pages that a user visits on the social network website. The banner may be a rotating gallery of advertisements or pictures of other users who have placed an advertisement with the user. There are two innovative concepts here. The first is replacing the commercial advertiser on the recipient user's banner ad-space by a ‘user advertiser’ who is trying to distinguish himself/herself from other requesters. The second is the existence of a cost function for the recipient of the banner that says “I appreciate your purchase and/or gift and in return I will show my appreciation by putting up your picture on my banner ad-space and think of you for some period of time (e.g. a week)”. Other dating websites do not allow one user to advertise on another user's pages or post a picture of the gifting user. The banner of the present invention can also be used for gifts; e.g. virtual flowers. When a user purchases virtual flowers (e.g. 3 tokens for purchase) and sends them to another user, the recipient can either accept or reject. If the virtual flowers are rejected, the gifting user gets back his/her tokens (full refund). If the virtual flowers are accepted then the recipient agrees to have the sender's picture rotate through the banner (Flower Carousel) for a period of time (e.g. 1 week).

15. The ability to purchase and send a gift to another user without knowing their physical address—where a user can purchase physical flowers/gifts for another user and send them to the other user, provided that the other user has indicated on his/her profile that he/she accepts gifts and that the site has the user's physical address in its internal database. The physical flowers/gifts can be purchased on the site or through partner sites and sent directly to the recipient user. In one aspect, the gifts (e.g. virtual flowers) cannot be sent until the intended recipient agrees to receive them from the gifting user. In another embodiment, the gifting user cannot send the physical gift (e.g. real flowers) to the recipient user unless they have already established a contact (goose).

16. The concept of the Watch List being updated with users' availability data from their Dating Calendar and incoming Goose requests allows better timing for a user to initiate new contacts. A user simply adds all the candidates he/she is interested in to the Watch List, and the list will indicate the opportune time to initiate a Goose request (contact request) with the candidates' availability data.

17. Financial security and economic compatibility, as well as physical attributes, are a major concern when it comes to dating. Accordingly, the system has the ability to offer multiple membership levels, and each member has the ability to select and/or set his or her own membership level. Using this feature, users may set their own perceived economic status; i.e. how much it will cost other members to communicate with them. For example, a user may choose a higher membership level to say to other users that “I am successful, and therefore I would only like to meet someone who is willing to pay 20 tokens to meet me.” While the standard membership level imparts the normal fee of 1 token per communication, higher membership levels increase this cost according to a status level (e.g. gold member=5 tokens, platinum member=10 tokens, diamond member=20 tokens).

Similar to limiting pending unanswered date requests, increasing the cost of communication for certain members also discourages date spamming. For instance, users can increase the cost to limit communication from those users who are not serious or who have unreasonable expectations due to physical attributes. Users will think twice before soliciting those members who have chosen to increase the cost of communication. While physical attributes may still play a part in selection, the focus becomes more on the actual qualities of the person solicited and whether there is an actual, not perceived, possibility of a match. Not only are unrealizable expectations limited by enforcing greater selectivity in solicitation, but valuable system resources are preserved by reducing overall online traffic. The cost of a response may also be relative to the membership level of the recipient user, or the higher membership level of the communicating users. For example, in one embodiment a gold member may choose a diamond member but if the goose is accepted, both members pay the higher cost set by the diamond membership level. The recipient is essentially saying “In return for your request I will demonstrate that I am successful by also paying 20 tokens to meet you.” By imposing the costs on recipient as well as the requester, greater selectivity in responses is also encouraged.

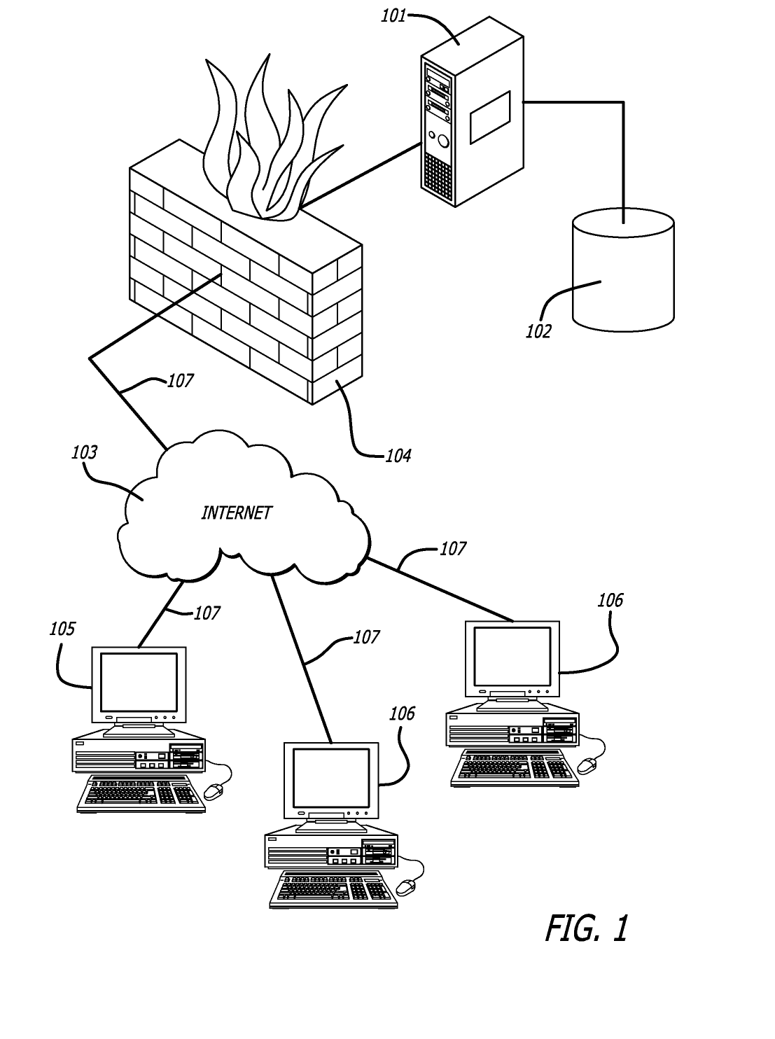

FIG. 1 illustrates a system diagram of an embodiment of the present invention, including a computerized system for, and method of, managing multiple communications between a plurality of users in a social network. Specifically, the diagram shows a computer server 101 connected to a database 102 connected to the internet 103 behind a firewall 104. A user 105 can access the server 101 through internet 103 to use the system. After establishing an account via server 101 the user 105 will have the ability to connect, via server 105, with other users 106 also connected to server 101 through Internet 103.

In this embodiment of the invention, server 101 is programmed to receive data input from users and is programmed to receive requests from users to communicate with other users. The server 101 acts as a broker for communications, or as a conduit, in which the users do not necessarily communicate directly with each other, but communicate through the server 101. The server 101 manages the communications by determining when users can communicate, when they cannot, how long users can communicate, and how long users have to establish communication or actually communicate with each other before canceling or disabling any established communication.

Server 101 may have several programmable settings which include:
A maximum number of unanswered requests any user may have pending with other users in the system at any one time;
A time limit for a user to respond to a particular request to communicate before canceling the request; and
A time limit for actually communicating after responding to a particular request to communicate.

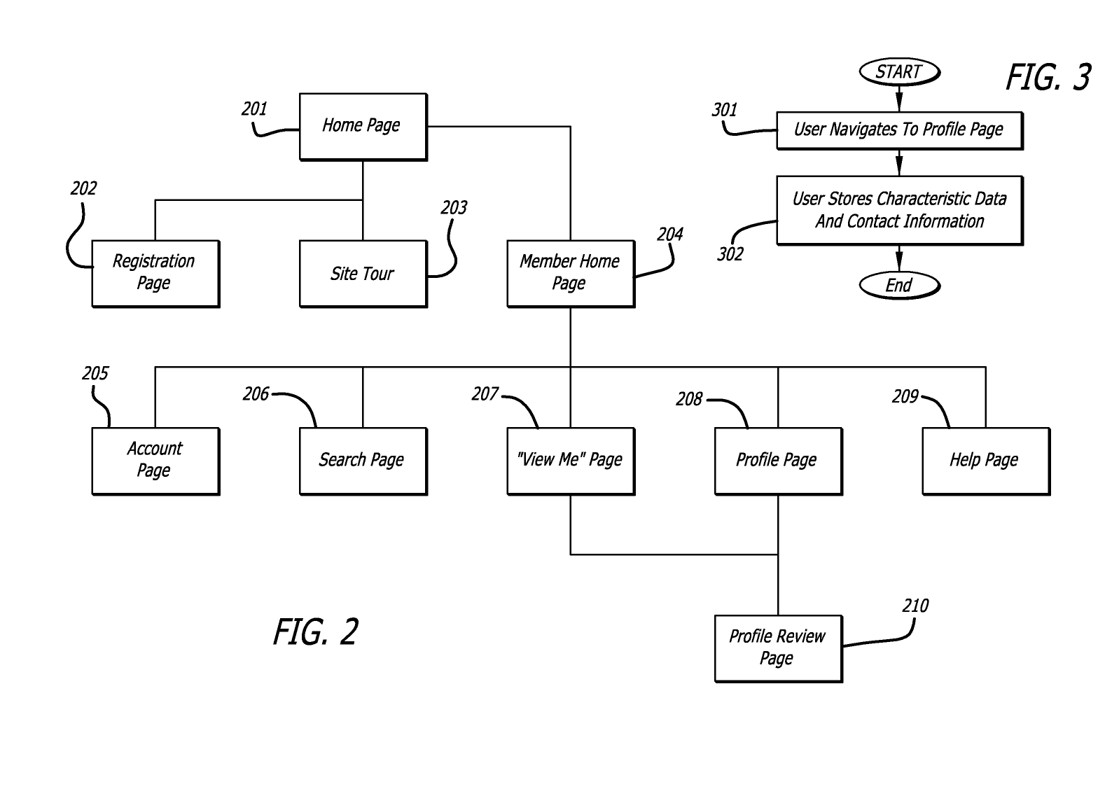

FIG. 2 is a website map, showing a visual representation of an embodiment of a system for, and method of, managing multiple communications between a plurality of users in a social network, the embodiment being a website. In this embodiment, the website includes a general home page 201 for non-members, a registration page 202 for non-members who wish to become members, a site tour 203 for those non-members who wish to discover how the system works before becoming a member, a member-specific home page 204, and several member web-pages including but not limited to: an account page 205, a search page 206, a “view me” page 207, a member profile page 208, a help page 209, and a profile review page 210.

In this embodiment, account page 205 is for the purposes of a user entering private information, and in some cases public information for storage in database 102. The database 102 has the ability to store both private and public data for any user of the system. Private information is not limited to, but may include the real name of the user, a true physical address such as a real home or business address, a unique identifier or screen name, and other contact information, as well as payment or account information. Public information may include certain characteristic information for which other users may identify with and/or search upon. Characteristic data may include, but is not limited to, a screen name or identifier, photos, a personal description, hobbies, physical traits, and system-generated statistical information.

In this embodiment, search page 206 is for the purposes of a user (including visiting non-members) to enter certain criteria data and performing a search for other users based upon a match of the entered criteria data and the characteristic data of other users of the system.

In this embodiment, “view me” page 207 is for the purpose of displaying certain characteristic data of a user to other users of the system, profile page 208 is for a user editing his or her own profile, help page 209 is for the purpose of providing help to members, and in some cases non-members, in using the system, and review page 210 is for the purpose of providing feedback from users who have previously established communications with the user whose profile is being displayed or edited.

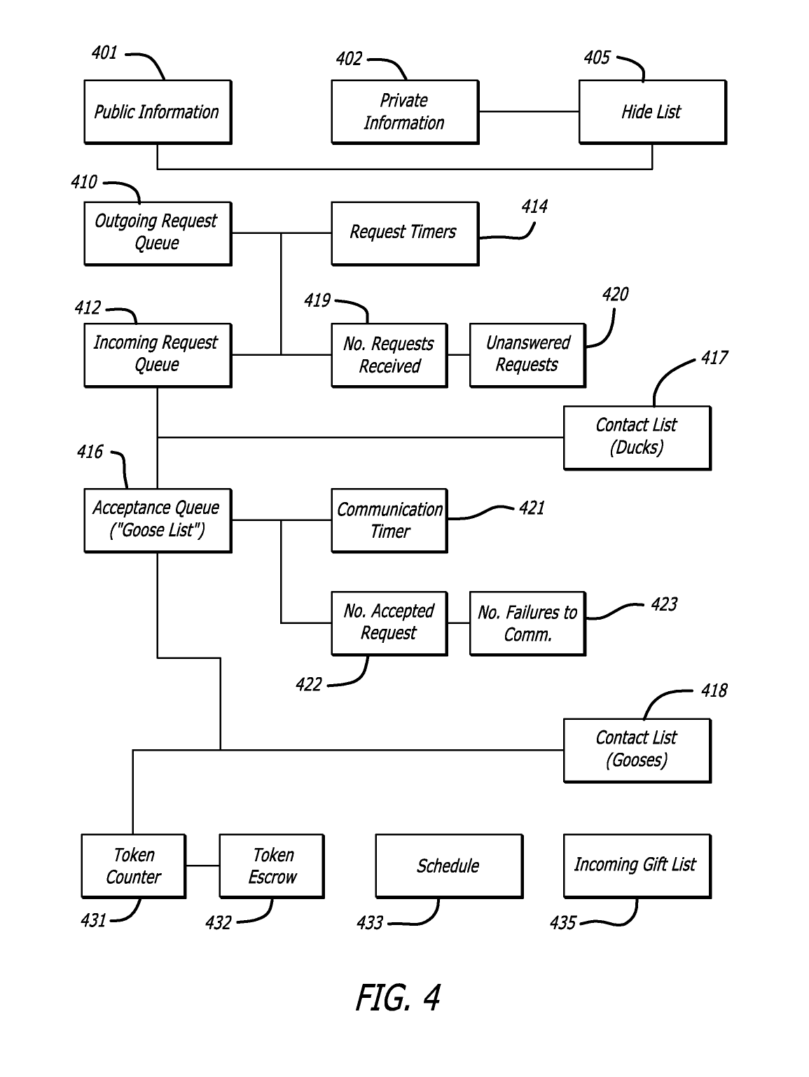

FIG. 3 is a flow chart illustrating an exemplary set of methods for storing characteristic data for a user. In an embodiment of the invention a user, after or upon registering with the system, will navigate 301 to his or her profile page and enter 302 characteristic data and relevant contact information which will be stored in the database 102. The information is entered for the purpose of providing matching data for future searches by other users and to generate interest in the social, physical, and mental characteristics of the user by other users. Users will seek out other users based upon characteristic data of the other users. This way, a user may alter who is attracted to, or who will view his or her profile, by entering or altering characteristic data.

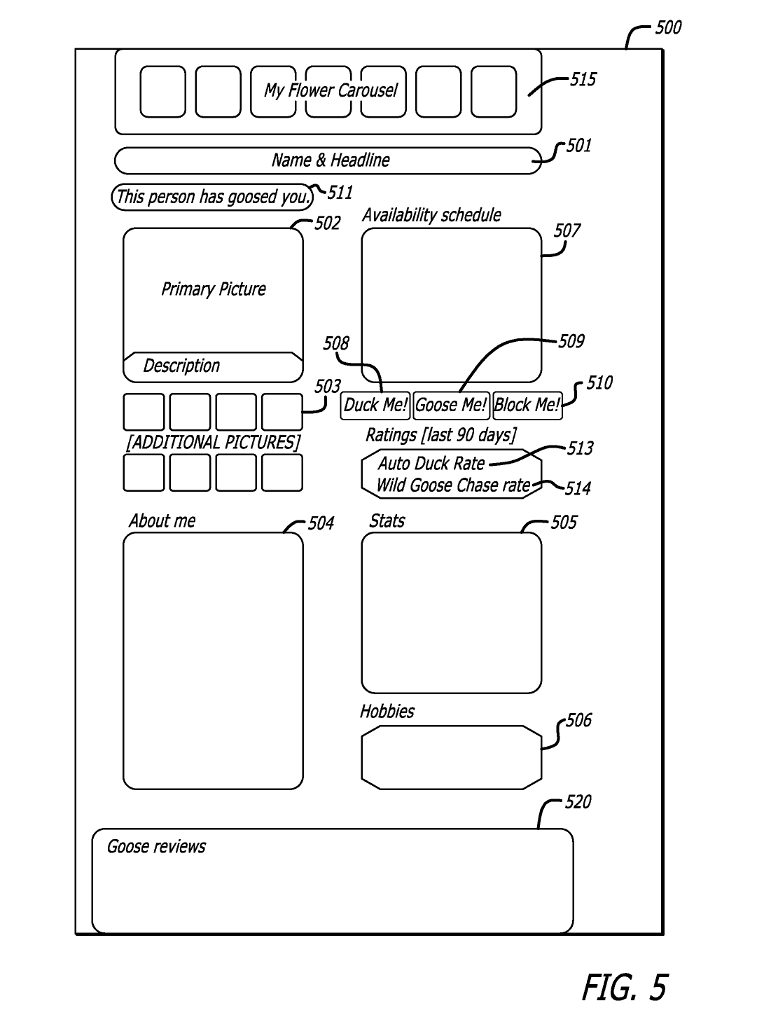

In FIG. 4, a relation between data information for a typical user is illustrated for an embodiment of the present invention. Each user will be represented in the server 101 and database 102 as a grouping of data fields and/or data registers. Characteristic data and contact information entered by each user in step 302 will be defined by certain public information 401 and private information 402 stored in the system. This information may be hidden from other users or users of the system. The user will also have a hide list 405 that maintains records of which public and private information is available to other users. By default, public information 401 is available to all other users and private information 402 is not available. A user can select some or all public information 401 to be displayed or hidden from any other user or group of users. The list of users and the data to be hidden or not hidden from each user is stored in hide list 405. This embodiment allows public information 401 to be hidden or not hidden. Other embodiments may or may not allow private information 402 to be hidden or not hidden in the same manner.

Each user of the system is allowed to initiate a contact with another user by sending a message request. The other user may or may not accept the request to establish the communication between users. Each user will have an outgoing request queue 410 and an incoming request queue 412. Each message request within a queue is associated with a request timer 414. Request timer 414 is started when a request to initiate a communication is sent by one user to another. The default for the request timer in this embodiment of the invention is typically 24 hours. The user who receives the request has 24 hours to accept the request to communicate. If the receiving user does not accept the request within the time limit then the request is removed from the requester's outgoing request queue 410 and is removed from the receiving user's incoming request queue 412, and the request is placed in both users' contact list 417. If the receiving user accepts the request then the request is removed from the receiving user's incoming request queue 412 and placed in the accepting user's acceptance queue 416 and the accepting user's contact list 418. The request is also moved from the requester's outgoing request queue 410 to the requester's contact list 418.

This embodiment also stores the number of times a user has received a request in the last 90 days 419 and the number of times a request has timed out 420. Using these numbers, server 101 calculates response rate for each user based the ratio of unanswered requests 420 to total requests received 419 (“Autoduck Rating”).

Each accepted request is associated with a communication timer 421. In this embodiment, the default for the communication timer is one week. Once the receiving user accepts the request then the system will allow the two users to communicate freely between each other. Communication may be made by system managed email or instant messaging. In an embodiment, the system also stores the number of times the user accepted a request to communicate 422 and the number of times the user subsequently failed to actually communicate 423 with the requesting user within the time limit set by communication timer 421. A percentage is calculated (“Wild Goose Chase Rating”) by server 101 based on the number of times the user accepted a request to communicate 422 and then subsequently failed to actually communicate with the requesting user 423 within the time limit set by communication timer 421. Likewise, if the requester fails to communicate within the time limit a similar (“Wild Goose Chase Rating”) percentage is calculated for the requester. In another aspect, if the accepting user does not actually communicate with the requesting user within the time limit of the acceptance timer 421 then the request is removed from the accepting user's acceptance queue 416, and placed in contact list 417. In this aspect, the request is also placed in the requester's contact list 417.

A communication exchange is established when a user requests to initiate communication with another user and the receiving user accepts the request. In this embodiment of the invention both users are charged for each established communication exchange. Typically, each user will pay in advance for a number of tokens. When a user accepts an incoming request both users will be charged one token. Token counter 431 maintains the number of tokens in the user's account. When token counter 431 reaches a zero balance the user cannot send or receive requests (other embodiments may allow requests to be sent but not actual communication until tokens are available). However, any user may opt to pay for another user's acceptance of a date request. In such a case, the requester sends a token with the request to the receiving user. When a user opts to send a token with a request to another user, two tokens are deducted from the requester's token counter 431 and none are deducted from the receiving user.

This embodiment also includes token escrow 432. When a request is sent token counter 431 is debited one token and placed into token escrow 432. This prevents a user from making more requests than the user has paid for. Token escrow 432 is not debited until the receiving user accepts the request. If the receiving user rejects the request then token counter 431 is re-credited. Users may also be allowed to send gifts to other users. Such gifts may be paid for, with a certain number of tokens, in the same manner as discussed for requests. Tokens are debited from token counter 431 and placed in token escrow 432 until the gift is ultimately accepted or rejected.

Schedule 433 is a group of records stored in database 102 describing a calendar and availability information for the user. The calendar may contain information about a particular activity that the person is interested in doing on a certain date, such as a concert or a skiing trip. Each user may publish in their profile “free days” and desired activities (“instant-date”). When one user sends a request to another user for an instant date, the request should be able to be tied directly to an activity within the calendar. Available dates within schedule 433 may also determine whether the user appears in another user's search results.

Incoming gift list 435 stores records in database 102 detailing gifts received from other users. A gift may be in electronic form or may be a real gift sent to the user's real home address. When the sending user purchases a gift (e.g. 3 tokens for a purchase) and sends them to another user, the receiving user can either accept or reject the gift. If the receiving user rejects the gift then the gifting user is re-credited his/her tokens (full refund). A list of all gifts received is stored in gift list 435. The embodiment will also maintain a rotating banner on each webpage. The receiving user may also agree to place the picture of the gifting user in the banner as a way to show generosity for receiving a gift from that user. In this embodiment, the banner is a rotating gallery of pictures of other users who sent an electronic gift to the user. For instance, a user can purchase an electronic flower for another user. An acceptance of an electronic flower means that the receiving user has agreed to have the sending user's picture rotate through the banner for a period of time (e.g. one week).

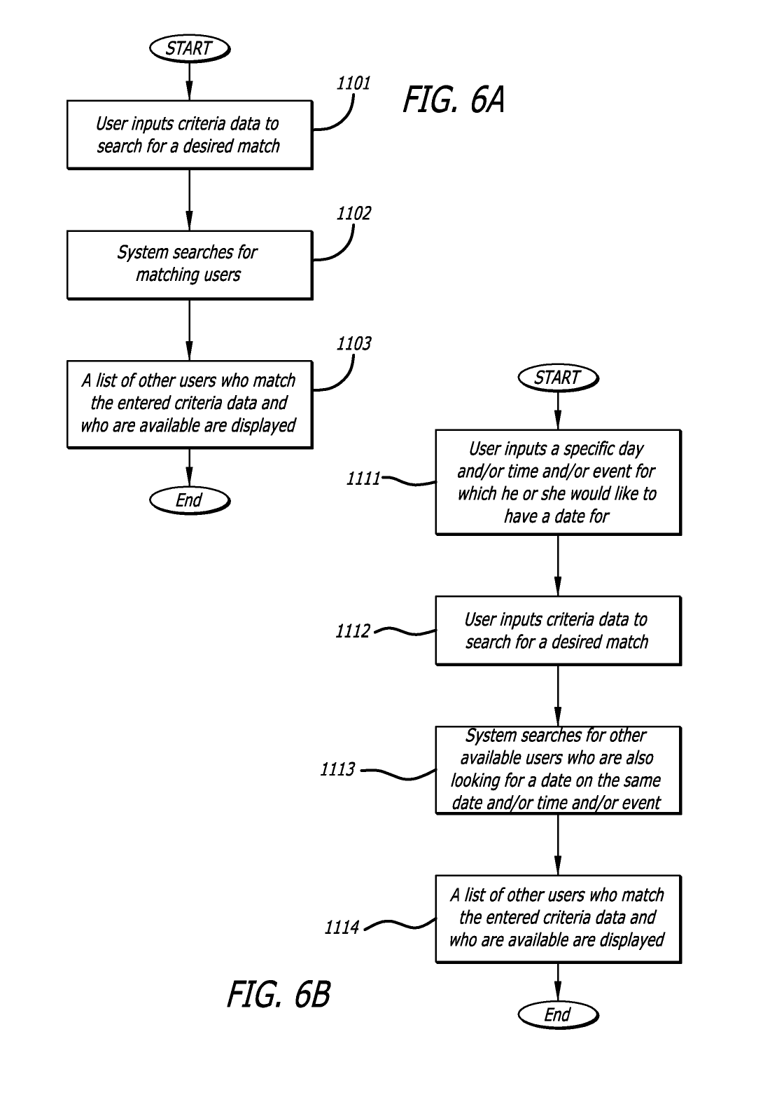

FIG. 5 is an example of a screen shot of a user profile in an embodiment of the invention. User profile 500 comprises characteristic data entered in step 302 and other relevant information. In this embodiment the information displayed includes a public name or identifier 501, several photos including a primary photo 502 and several additional photos 503, a personal description 504, physical traits and character statistics 505, hobbies 506 an availability schedule 507, and a rotating banner 515 (e.g. Flower Carousel).

Availability schedule 507 is for the purpose of displaying dates and times for which the user is available for a date. The information is stored and retrieved from schedule 433. Availability schedule 507 is a calendar on a user's profile showing the dates on which that user is available. The calendar may contain information about a particular activity that the person is interested in doing on a certain date, such as a concert or a skiing trip. For instance, the user may post to availability schedule 507 certain events for which the user is seeking a companion. Free days are displayed in green, whereas days with desired activities (“instant date”) are in yellow. In an embodiment, hovering the mouse cursor over a yellow day pops up information about the desired activity on that day.

In an embodiment of the invention, the profile page also displays several controls for initiating or rejecting communication with the user whose profile page is displayed. In particular, three buttons are present: a “Duck me” button 508, a “Goose me” button 509, and a “Block me” button 510. This embodiment uses the terms “duck”, “goose” and “block” to represent methods to postpone, initiate, or block communication with another user, respectively.

If the user whose profile is displayed has previously sent a date or message request to the user who is viewing the profile then profile 500 will display a message 511 stating “This person has goosed you.” The user viewing the profile may then press the “Duck me” button 508 to respond to the user by postponing communication. Postponing communication effectively informs the requesting user that the receiving user has not rejected the request but does not want to communicate immediately. The communication will be delayed. The request is removed from the receiving user's incoming request queue 412 and placed in the receiving user's contact list 417. The request is also moved from the requester's outgoing request queue 410 to the requester's contact list 417. Postponing the communication does not result in an increase in the number of unanswered requests 420. Thus, there is an incentive for users to respond to all incoming date or message requests.

Pressing the “Goose me” button 509 will request a communication exchange with the user who is “goosed” (the person who owns the profile on which the “Goose me” button 509 was pressed). A request will be posted to the requester's outgoing request queue 410 and recipient's incoming request queue 412. Where the viewing user has been “goosed” by the user whose profile is being viewed pressing “Goose me” 509 will establish a communication exchange between the users. The request is removed from the recipient's incoming request queue 412 and placed in the recipient's acceptance queue 416 and recipient's contact list 418. The request is also moved from the requester's outgoing request queue 410 to the requester's contact list 418.

Pressing the “Block me” button 510 on a user's profile 500 will result in the user being blocked from viewing the profile of the user who pressed the “Block me” button 510. The user pressing “Block me” 510 will be allowed to select what information should be blocked from the user (communication, information, profile or partial profile, or search results). Hide list 405 is updated after the viewing user makes his or her selections. If communication is blocked from a user, the user being blocked cannot send any unwanted communication or date spam the blocking user. Thus, date spamming is diminished by allowing users to block undesirable candidates and potential communication with other potential matches is enhanced by limiting the channels of communication between users.

In this embodiment of the invention, profile 500 also displays several automated ratings. In particular the invention will display an “Autoduck rate” 513 and a “Wild goose chases” percentage 514. The “Autoduck rate” 513 specifies the ratio calculated from the number of times a user has received a request in the last specified number of days (e.g. 90 days) 419 and the number of times a request has timed out 420. The “Wild goose chases” percentage 514 is a percentage calculated from the number of times a user established communication exchange 422 (resulting from an accepted request) and the number of times the user subsequently failed to actually communicate within a specified time 423. For instance, User A may initiate a “goose” request to User B. User B may accept the request by also selecting to “goose” user A. User A may then try to communicate with User B but User B may not want to actually communicate with User A. If User B does not actually communicate with User A with a specified period of time (e.g. one week), then User B's “wild goose chases” percentage 514 will increase. Conversely, if User A fails to send at least one communication within the specified time after the connection was established, then User A's percentage will increase. The “Wild goose chases” percentage 514 is calculated by server 101 from data stored in database 102. In this embodiment, both ratings are based on activity during a preset period of time (e.g. the last 90 days). Because a high “wild goose chase” rating would discourage other users from seeking to contact the user, this method encourages prompt response time and selectivity in solicitation and responses.

In this embodiment of the invention, if the user whose profile is displayed has goosed the viewing user (either by request or reply) and an actual communication exchange has occurred then the viewing user will have the option to post a comment 520 to the profile page of the displayed user. The user whose profile comment 520 was posted will have the option of keeping or removing the comment. Other embodiments may restrict the user from removing comment 520.

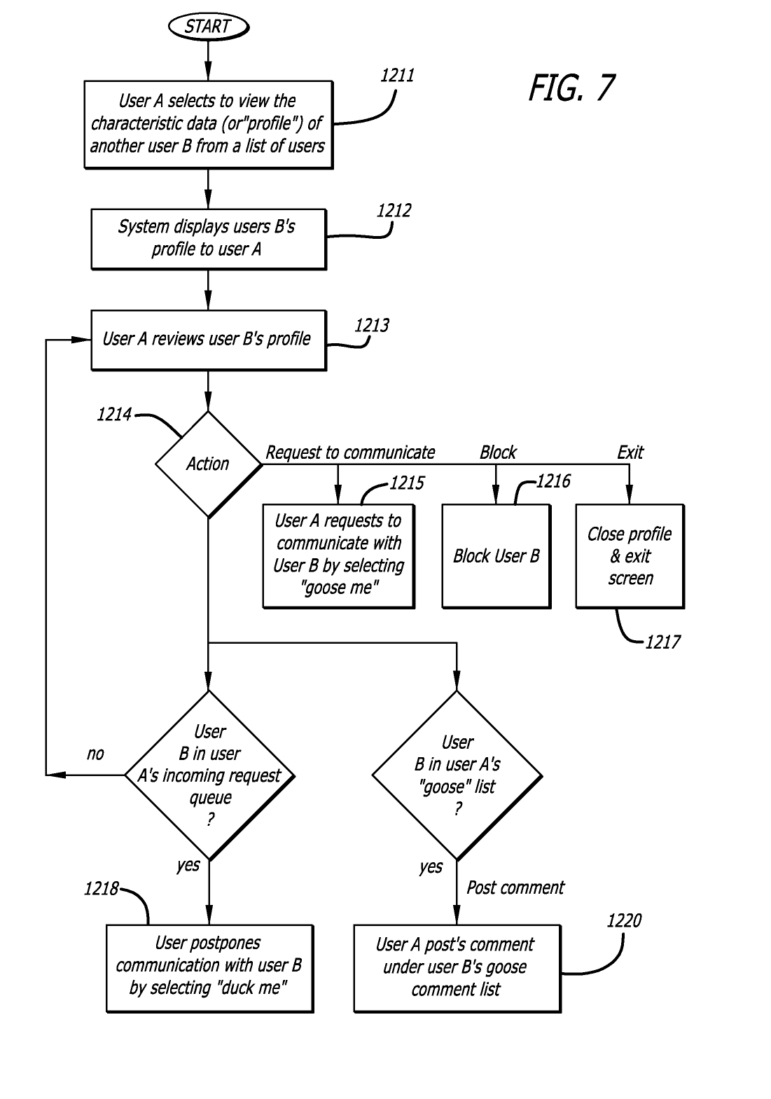

FIGS. 6A and 6B are flow charts illustrating an exemplary set of steps to search for other users in the system. In step 1101, a user will first initiate a search for another user by inputting into the system certain criteria data that the user finds desirable. In step 1102, the system will then search for matching users. In step 1103, the system then returns to the searching user a list of other users who match the entered criteria data and who are not hidden from the user performing the search.

The search may also be limited by the availability schedule 507 of other users. In step 1111, a user can input specific rendezvous information including a specific day, time, and/or event for which the searching user wants companionship. For instance, the searching user may state that he or she would like to attend a movie premier or concert on the next Saturday. Step 1112 illustrates that a user may further tailor the request by other criteria data. In step 1113, the system will search for those other users who also want a date for the same event. In step 1114, the system then returns to the searching user a list of other users who also want companionship for the particular day, time and/or event, and who match the entered criteria data and who are not hidden from the user performing the search.

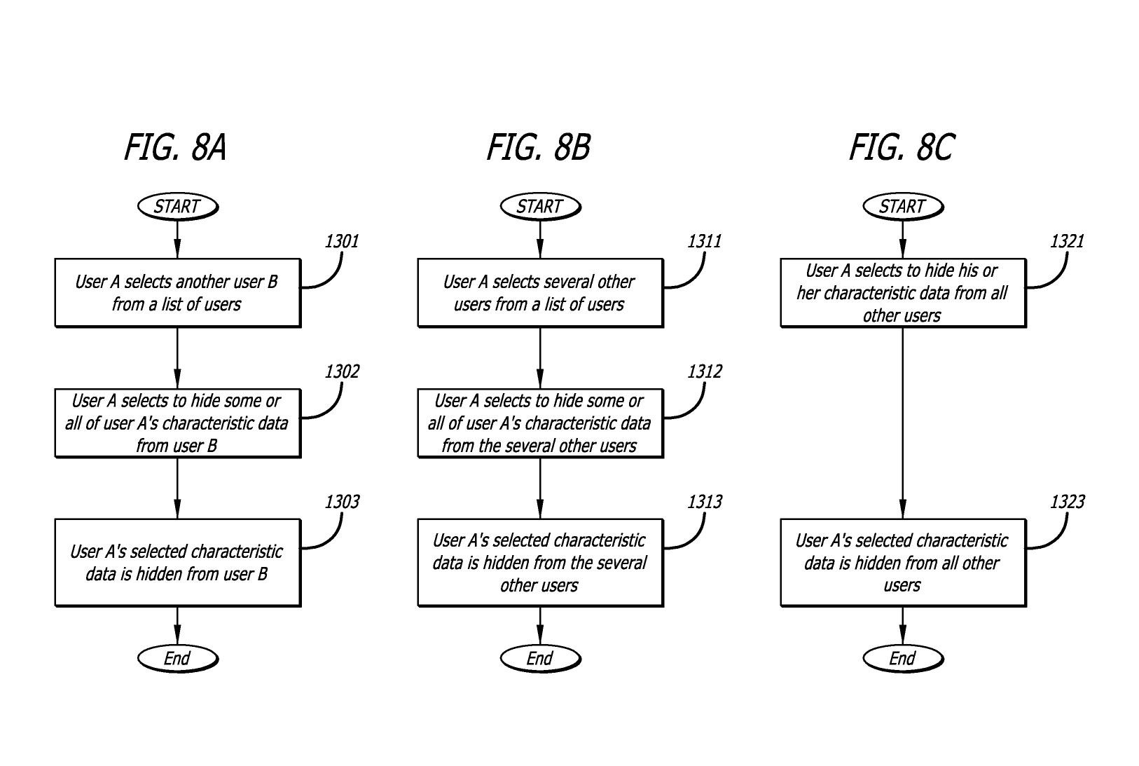

FIG. 7 is a flow chart illustrating an exemplary set of method steps to be performed by one user upon the profile of another user. As in most online social networks, a user participates through interaction with the profiles of other users. Once a list of other users has been returned by a search the user may choose to interact with the profile of a user from the list. In step 1211, the searching user selects to view the characteristic data, or “profile,” of another user who was in the list of users returned by the system. In step 1212, the system then displays the selected user's profile on the screen. Essentially, the viewing user is transferred to the “view me” page 207 of the selected user. In step 1213, the user reviews the selected user's profile. The viewing user then has the option of performing an action 1214 upon the profile of the selected user. In step 1215, the user initiates a request to communicate with the selected user by pressing the selected user's “Goose me” button 509. Alternatively, in step 1216, the user can block the selected user from viewing his or her own profile or part of the profile by pressing the selected user's “Block me” button 510. Step 1217 illustrates a situation in which the user can stop viewing the profile, and exit the screen. If the displayed user has requested to initiate contact with the viewing user (via the “goose me” button) then, as shown in step 1218, the viewing user may press the “Duck me” button 508 to respond to the user by postponing communication. The “Duck me” button provides a way for a solicited person who is busy but interested to delay a communication without discouraging the solicitor. Finally, in step 1220, if an actual communication exchange occurs between the two users then the viewing user will have the option to post a comment 520 to the profile page of the displayed user. Comments are typically displayed on users' profile review page 210. The ability for one user to post comments on another user's profile page encourages respectful behavior between users who have established communication and selectivity in choosing who to contact.

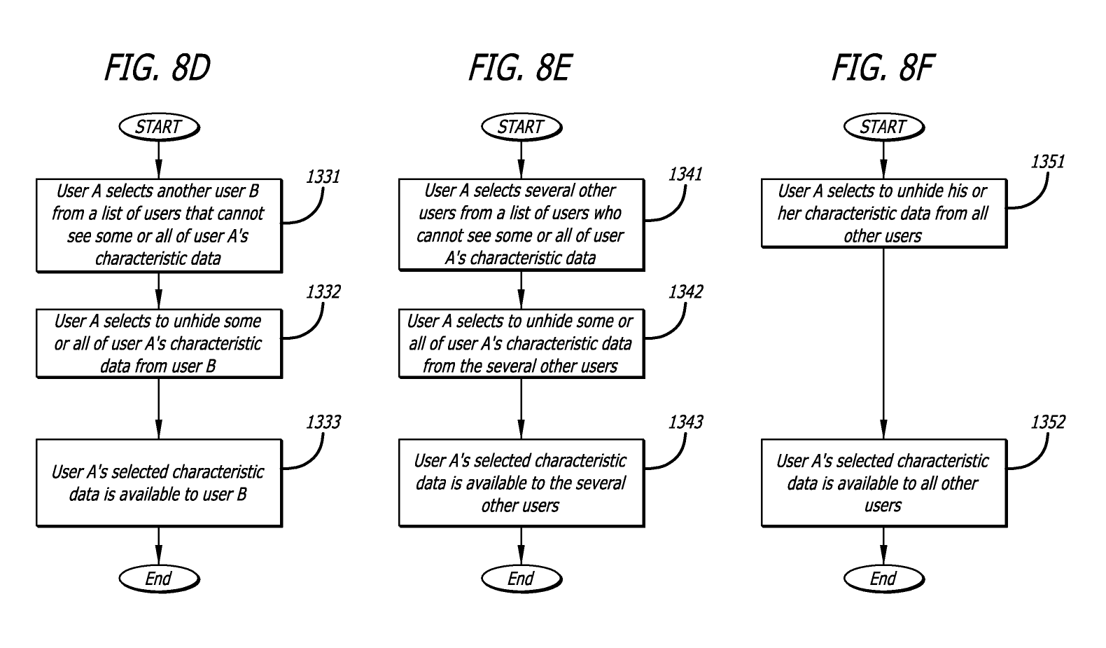

FIG. 8A through 8F are flow charts illustrating an exemplary set of method steps for hiding and unhiding all or some of a user's characteristic data. In this embodiment of the invention, a user may select to hide his or her profile from a particular user, several users, or all users. The user may also hide all or part of his or her profile, or parts of the characteristic data that would otherwise be displayed to other users. In step 1301, the user selects another user from a list of users. In step 1302, the user selects to hide his or her profile from the selected user. In step 1303, the system restricts the selected user from seeing the hidden profile. In step 1311, the user selects several other users from a list of users. In step 1312, the user selects to hide his or her profile from the selected other users. In step 1313, the system restricts the selected users from seeing the hidden profile. In step 1321, the user selects to hide his or her profile from all other users. In step 1323, the system restricts all other users in the system from seeing the hidden profile.

In this embodiment of the invention, a user may select to unhide his or her profile from a particular user, several users, or all users. The user may also unhide all or part of his or her profile, or parts of the characteristic data which would otherwise be hidden to other users. In step 1331, the user selects another user from a list of users. In step 1332, the user selects to unhide his or her profile for the selected user. In step 1333, the system allows the selected user to see the otherwise hidden profile. In step 1341, the user selects several other users from a list of users. In step 1342, the user selects to unhide his or her profile for the selected other users. In step 1343, the system allows the selected users to see the otherwise hidden profile. In step 1351, the user selects to unhide his or her profile from all other users. In step 1352, the system allows all other users in the system to see the otherwise hidden profile. This feature allows users to block undesirable candidates on an individual basis so that potential communication with other potential matches is not diminished.

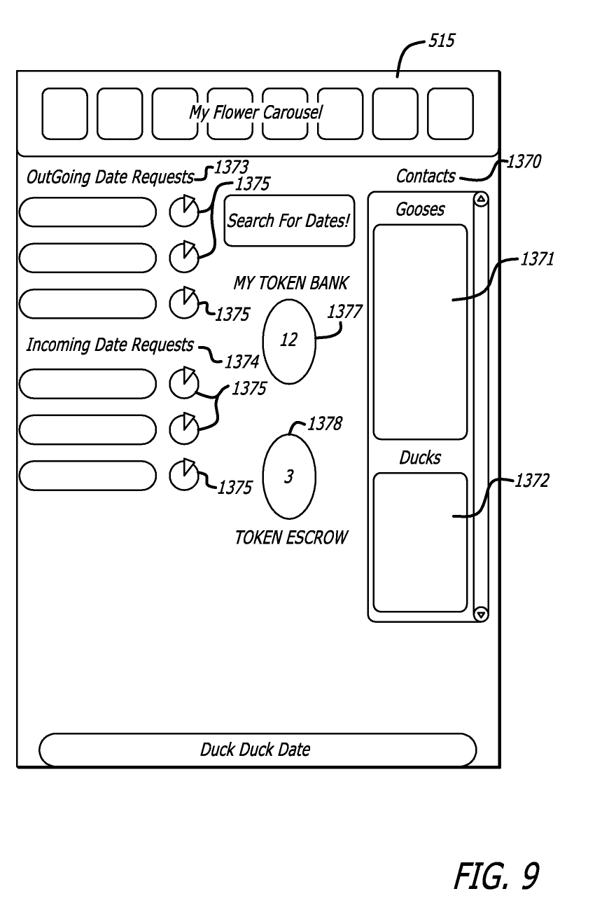

FIG. 9 is an example of user home page 204 that manages contacts and communications for a user. In an embodiment of the invention, home page 204 displays the user's established contacts list 1370, including a list of users who “goosed” (requested or accepted a request to communicate) the user 1371 and a list of users who “ducked” the user 1372. The page also displays the user's current outgoing requests 1373 and incoming requests 1374. Each request has a clock 1375 which indicates a timer (usually 24 hours) in which the request will remain valid. Each clock 1375 is tied to a request timer 414. If a clock 1375 associated with either an outgoing date request 1373 or an incoming date request 1374 expires then the related request is moved to the “ducks” list 1372 unless the user who received the request responds to the request within the time limit.

In this embodiment of the invention a user is charged for each established communication exchange. Typically, each user will pay for a number of tokens. The user home page includes a number of remaining tokens 1377 in the user's account. The number of remaining tokens 1377 is tied to token counter 431. When a user initiates a request, a token is moved into token escrow 432 and the number of tokens in token escrow 432 is displayed in token escrow counter 1378 on the user's home page 204. When a user accepts an incoming date request 1374 both users will be charged one token. When the number reaches zero the user cannot send another outgoing date request 1373 or accept an incoming date request 1374 until additional tokens are obtained. However, any user may opt to pay for another user's acceptance of a date request by sending a token with the request. A user receiving a date request may accept an incoming date request even if the user's number of tokens is zero if the initiating user sends a token with the request.

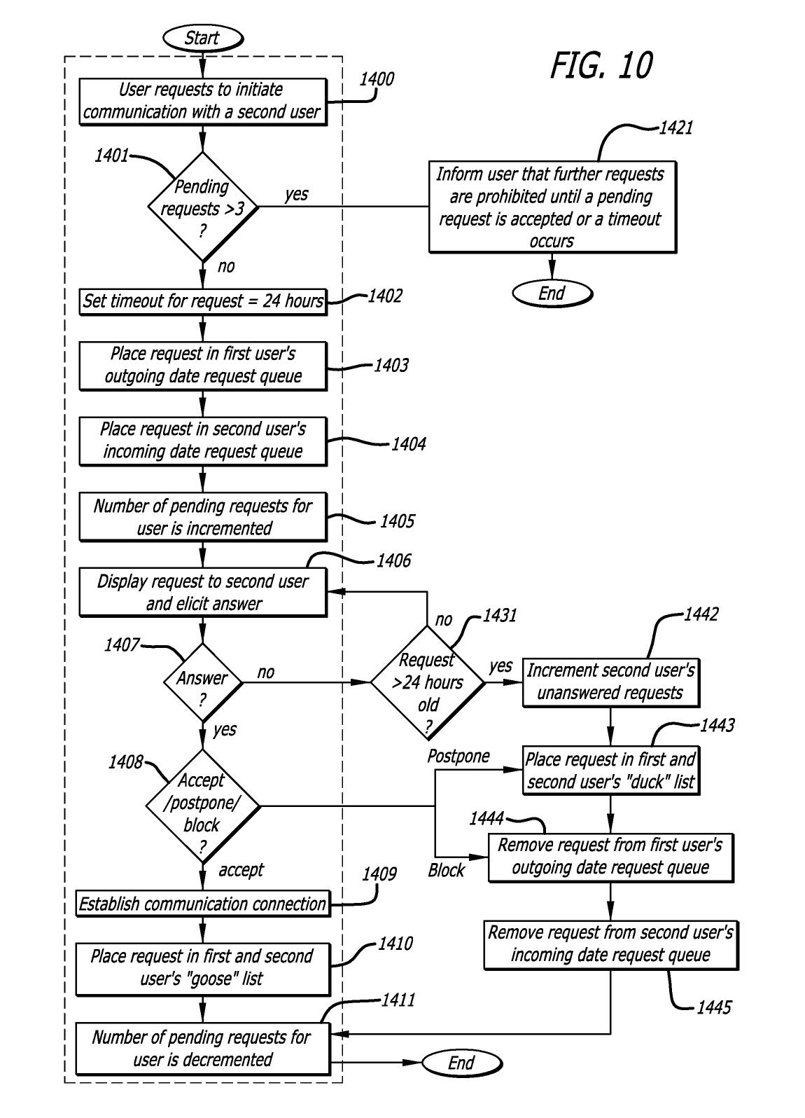

The flow chart of FIG. 10 illustrates how communication is established between two users in this embodiment of the invention. A user is not allowed to have more than a set number of outgoing date requests 1373 in outgoing request queue 410. A date request is an initiation of an interaction or communication with another member. In this embodiment, the number is initially set to three, for example, by an administrator of the system, and the number does not normally change during operation of the system. This does not preclude the administrator of the system from changing the number during runtime in certain situations. The system may be modified to accept another number (usually depending on the size of the user population) which achieves all of the same objectives of the invention. In step 1400, a user requests to initiate communication with another user. This typically occurs when the requester selects “Goose me” button 509. In step 1401, the system checks whether the number of pending requests is greater than three. If the user does not have more than three pending requests and the user has sufficient tokens to pay for the communication then the system will allow the request. In step 1402, the system sets the timeout 414 for the request. The timeout is typically set to 24 hours. In step 1403, the system places the request in the user's outgoing date request queue 410. In step 1404, the system places the request in the receiving user's incoming date request queue 412. In step 1405, the system increments the user's number of outgoing date requests. In step 1406, the system presents the request to the receiving user by placing the request in the receiving user's incoming date request queue 412. In step 1407, the system waits for the receiving user to answer the request. A user may answer 1408 the request by postponing the request (“duck”), by accepting the request (“goose”), or by blocking the request. As illustrated by step 1409, if the request is accepted the system establishes a communication connection between the users. In step 1410, the system then moves the request from the requesting user's outgoing date requests queue 410 to the requesting user's “goose” list 418, and moves the request from the receiving user's incoming date requests queue 412 to the receiving user's “goose” list 418. In step 1411, the system then decrements the soliciting user's number of pending outgoing date requests.

In an alternative flow of this embodiment, a user may try to send more outgoing date requests 1373 than is allowed. In step 1401, the system checks whether the number of pending requests is greater than three. If the user has more than three pending requests then the system will not allow the request. In step 1421, the soliciting user will be prevented from making any further requests and is informed that he or she must wait until either a pending outgoing date request times out or is accepted by a solicited user.

In another alternative flow to FIG. 10 (not shown), each user selects a membership level prior to the request to communicate. The system receives from the requestor a request to initiate a communication exchange with a second user in the social network. The system sets the fee for the communication based on the higher of the corresponding membership levels of the communicating users. Before displaying the communication request to the recipient, the system tallies a total amount of selected fees for pending unanswered requests by the requestor, and verifies the total amount of selected fees is less than an amount in the requestor's account. The request to initiate the communication exchange is displayed to the recipient only if the total amount of selected fees for pending unanswered requests by the requester is less than the amount the requestor's account. Limiting the number of pending unanswered date requests and/or increasing the cost of communication for certain members discourages date spamming and encourages selectivity in solicitation and responses.

In another alternative flow, a receiving user may not answer the incoming date request 1374 for more than timeout 414 shown by clock 1375. In step 1431, the system checks whether the request is over twenty-four hours old. If the request is more than the timeout period (e.g. 24 hours old) then the request is expired. Steps 1442 to 1445 and 1411 detail expiring a request. In step 1442, the system increments the receiving user's unanswered requests 420 (“autoducks”). In step 1443, the system places the request in the receiving user's “duck” list 417. In step 1444, the system removes the request from the requester's outgoing date request queue 410. In step 1445, the system removes the request from the receiving user's incoming date request queue 412. Turning to step 1411, the system decrements the requester's number of pending outgoing date requests. Because a high “Autoduck” rating would discourage other users from seeking to contact the user, this method encourages prompt response time and selectivity in solicitation and responses.

In another alternative flow, a receiving user may answer the incoming date request 1374 by postponing (or “ducking”) the communication. In step 1408, the receiving user postpones the incoming date request by selecting “Duck me” button 508 from the requester's profile 500. In step 1443, the system places the request in the receiving user's “duck” list 417. In step 1444, the system removes the request from the requester's outgoing date request queue 410. In step 1445, the system removes the request from the receiving user's incoming date request queue 412. Turning to step 1411, the system decrements the requester's number of pending outgoing date requests. The receiving user's unanswered requests 420 is not incremented.

In yet another alternative flow of the present invention, a receiving user may answer the incoming date request 1374 by blocking the communication. In step 1408, the receiving user blocks the incoming date request by selecting “Block me” button 508 from the requester's profile 499. In step 1444, the system removes the request from the requester's outgoing date request queue 410. In step 1445, the system removes the request from the receiving user's incoming date request queue 412. Turning to step 1411, the system decrements the requester's number of pending outgoing date requests. The receiving user's unanswered requests 420 is not incremented and the request is not placed in duck list 417.

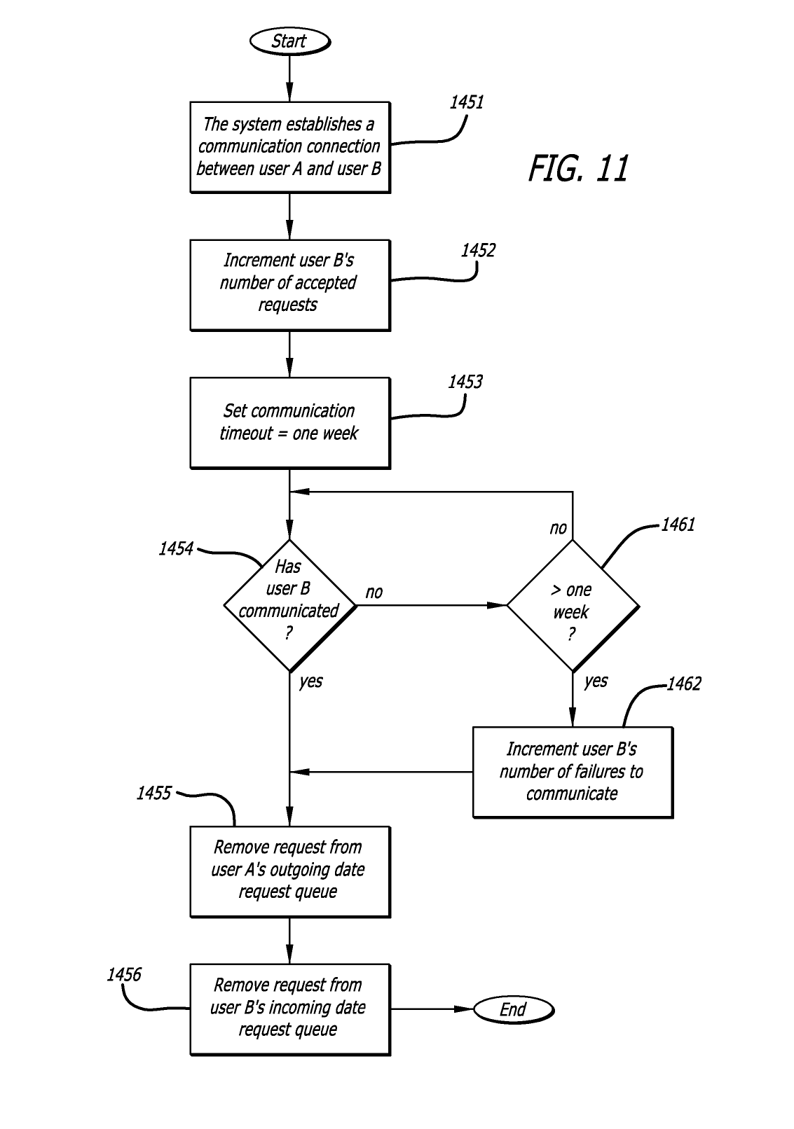

FIG. 11 illustrates a time limit imposed on a user who has accepted a request to communicate to respond to the requesting user. In step 1451, the system has already established a communication connection between two or more users. In step 1452, the system increments the number of accepted requests 422 for the user who received and accepted the request. In step 1453, communication timer 421 for the communication exchange is set to a predetermined time limit. In an embodiment this time limit is typically one week. In step 1454, the system waits to see if the accepting user has actually sent some form of communication to the user who sent the request. Communication is typically in the form of email or instant message. Steps 1455 through 1456 illustrate steps taken after a communication actually takes place. In step 1455, the request is removed from the requester's outgoing date request queue 410. This allows the user to make more requests if he/she had reached the maximum request limit. In step 1456, the request is also removed from the receiving user's incoming date request queue 412. The accepted request will remain in each users' contact list 418, displayed as goose list 1371, until removed by the user.

Step 1454, 1461, 1462, 1455 and 1456 illustrate a timeout condition. In step 1454, the system waits to see if the accepting user has actually sent some form of communication to the user who sent the request. In step 1461, the system verifies that it has not been over the time limit (e.g. 1 week) since the request was accepted. If the time limit has not been exceeded then the system returns to step 1454. In step 1462, the time limit has been exceeded. In step 1462, the receiving user's number of failures to communicate 423 is incremented. In step 1455, the request is removed from the sending user's outgoing date request queue 410. This allows the user to make more requests if he/she had reached the maximum request limit. In step 1456, the request is also removed from the receiving user's incoming date request queue 412. The accepted request will remain in each users' contact list 418, displayed as goose list 1371, until removed by the user.

In another embodiment, the server is programmed to allow communications in the social network to users actively using mobile devices in a common geographic location. Users should possess a GPS-enabled internet capable cell-phone or PDA that is connected to the social network. The geographic location of either user can be determined by GPS, cell phone triangulation, wi-fi triangulation, blue-tooth triangulation, or any other means known in the art. Various devices and methods exist for integrating these methods and devices with internet applications, and patents have issued for such systems, including U.S. Pat. No. 6,131,067 to Girerd, et. al., and U.S. Pat. No. 6,456,854 to Chern, et al., both incorporated herein by reference. Any device or method suitable for broadcasting the geographic locations of the users or their devices to a server would be suitable for use with the present invention.

In an embodiment, a user of the system logs onto the server through a portable device such as a mobile phone or PDA with internet capability. The user then proceeds to indicate his/her level of security in terms of a real-time position security region. The region can be user-configurable to a state, city, or radius surrounding the specific location of the user. The security region is typically a pre-set range (e.g. 100, 1000, or 5000 meters) in which the user would be searchable to other users or potential dates who are proximate to the user. A minimum and/or a maximum setting can be entered. Setting a minimum can ensure that the potential date not be so close as to create an awkward situation. The user then enters the usual desired traits for the potential contact (e.g. height, occupation, etc. . . . ). The user then initiates the server of the present invention to place his/her profile in a “live” status in real time. The user's profile is then displayed to all potential contacts meeting the desired traits in real-time within the specified security range. The user can also see the other users who are “live.”

For instance, Sally enters her credentials on her internet-capable mobile phone, and she sees a list of members and their pictures who are within her set range: Mike (1000 meters away), Bob (100 meters away), and John (10000 meters away). In one aspect, the system can display the members on a map including their position. A user's exact position is typically not displayed. Each displayed user is represented by a dot and/or uncertainty circle representing the displayed user's security region (e.g. Mike is represented by a circle representing 100 meters in diameter). The users are only visible to each other when their respective circles, or security regions, overlap.

After the user searches and decides on who to make a request to communicate with he/she initiates a request (goose) using the rules of the preferred embodiments. The rules may be modified and timing periods reduced to accommodate for real-time activity (such as reducing the Autoduck time limit to 15 minutes instead of 24 hours). Also the server may allow communication via a secure call or cellular text message instead of email. In this instance, both recipient and requester do not need to disclose their phone numbers. The server will arrange the communication exchange according to the rules of the present invention. This innovation allows persons to use the present invention to instantly find not only a desirable match who is compatible in similar likes and interests but someone who is also immediately available and geographic accessible.

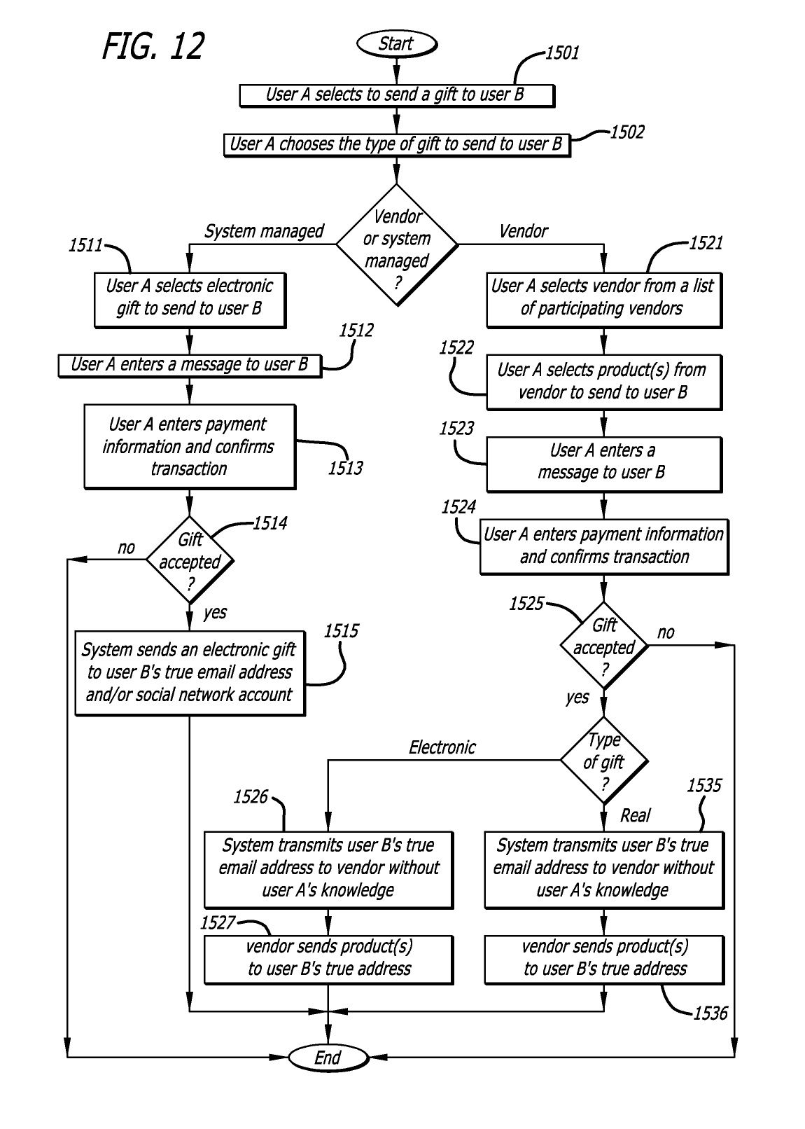

FIG. 12 illustrates sending a gift to another user. In another embodiment of the present invention a soliciting user may send a gift to a receiving user by selecting the user from a list returned by a search and clicking on a button on the receiving user's profile which is designated to start the process of sending a gift, or by clicking on a “gift button” on the record for a user returned as part of a list. The gift can also be sent as part of a “goose” request or “goose” acceptance. In step 1501, the soliciting user selects another user to receive a gift. In step 1502, the sending user chooses the type of gift. The gift can be either an electronic gift or a real gift. Electronic gifts are digital and typically sent via the internet through the system. An electronic gift can be in the form of a electronic card or letter, drawing, animation, sound or other viewable or audible item. A real gift is sent through US Mail or other carrier and can be any tangible item, such as flowers, candy, etc. The gift can also be entirely managed by the system of the present invention or can be selected from a participating vendor.

Steps 1511 to 1514 define the steps of sending an electronic gift managed by the system. In step 1511, the sending user selects the electronic gift from a list of gifts displayed on a webpage. In step 1512, the sending user fills out any relevant information that is to be associated with the gift. This could include a message to the receiving user. In step 1513, the user enters payment information (if necessary) and confirms the transaction. The gift is typically not sent to the receiving user unless it is accepted by the receiving user. In step 1514 the user receives a request from the system regarding gift. If the user accepts the gift the system, in step 1515, sends the electronic gift to the true email address and/or social network account of the receiving user. Typically, the true email address of the receiving user is not revealed to the sending user unless the receiving user authorizes the sending user to view the address.

Steps 1521 to 1527 define the innovation of sending a gift purchased through an affiliated vendor through the social network as part of the dating process. In step 1521, the user selects a vendor from a list of participating vendors. In step 1522, the user selects a number of products from the vendor to send to the receiving user. In step 1523, the user fills out any relevant information that is to be associated with the gift, including a message to the receiving user. In step 1524, the user enters payment information (if necessary) and confirms the transaction. In this embodiment, the gift will not be sent to the receiving user unless it is accepted by the receiving user. In step 1525, the user receives a request from the system regarding gift. The gift will be sent to the receiving user only if accepted by the user.

If the user accepts an electronic vendor gift, the system, in step 1526, discretely transmits the receiving user's true address to the vendor without revealing the address to the sending user. In step 1527, the vendor sends the gift to the receiving users true email address. If the gift is a real vendor gift, the system, in step 1535, retrieves and discretely transmits the receiving user's true mailing address to the vendor without revealing the address to the sending user. Then, in step 1536, the vendor sends the gift to the receiving user's true mailing address.

The system further enables a user to purchase an advertisement to be displayed as part of public information 401 or private information 402 of the second user. A user can advertise on profile page 500 that advertisements are welcomed for, or the requesting user can make an offer through the system in the same manner as a request to establish communication. The person wishing to advertise sends a request to the user who will potentially publish the advertisement (publisher). The first user purchases the advertisement space through the website. The system is setup to accept payment and sell advertising (e.g. using a credit card or tokens). The user sends a request to the potential publisher to place the advertisement (e.g. my picture, political message, product advertisement, etc. . . . ). The potential publisher then decides to accept or reject the advertisement. Once the request is accepted, the fee is transferred and the advertisement begins to display on publisher's profile page 500. The advertisement is usually fixed for a certain time. In another embodiment the system sets this time; for example, one token for one week. This embodiment can be modified so that the publisher is allowed to set or modify the fee and the time for which the advertisement is displayed.

The advertisement can also be directed specifically at the publisher, and not other users. In this manner, once the publisher accepts the request the advertisement is displayed as part of the publisher's private information 402 and typically is viewed only by the publisher when the publisher uses the social network system. For example, whenever the publisher is conducting searches, viewing other profiles, or viewing or modifying his or her own profile, a picture of the user who bought the advertisement is displayed at the top of the screen. For both public and private advertisements there may be a rotating banner on each webpage (e.g. the Flower Carousel described above). The banner is a rotating gallery of advertisements that other users have placed with the publisher. For instance, an advertising user can buy space to advertise his picture on the publisher's banner. An acceptance means that the receiving user has agreed to have the sending user's advertisement or picture rotate through the banner for a period of time (e.g. one week). The advertisement can also be small, such as a thumbnail picture, and show up as part of a user's search result list which includes the publisher.

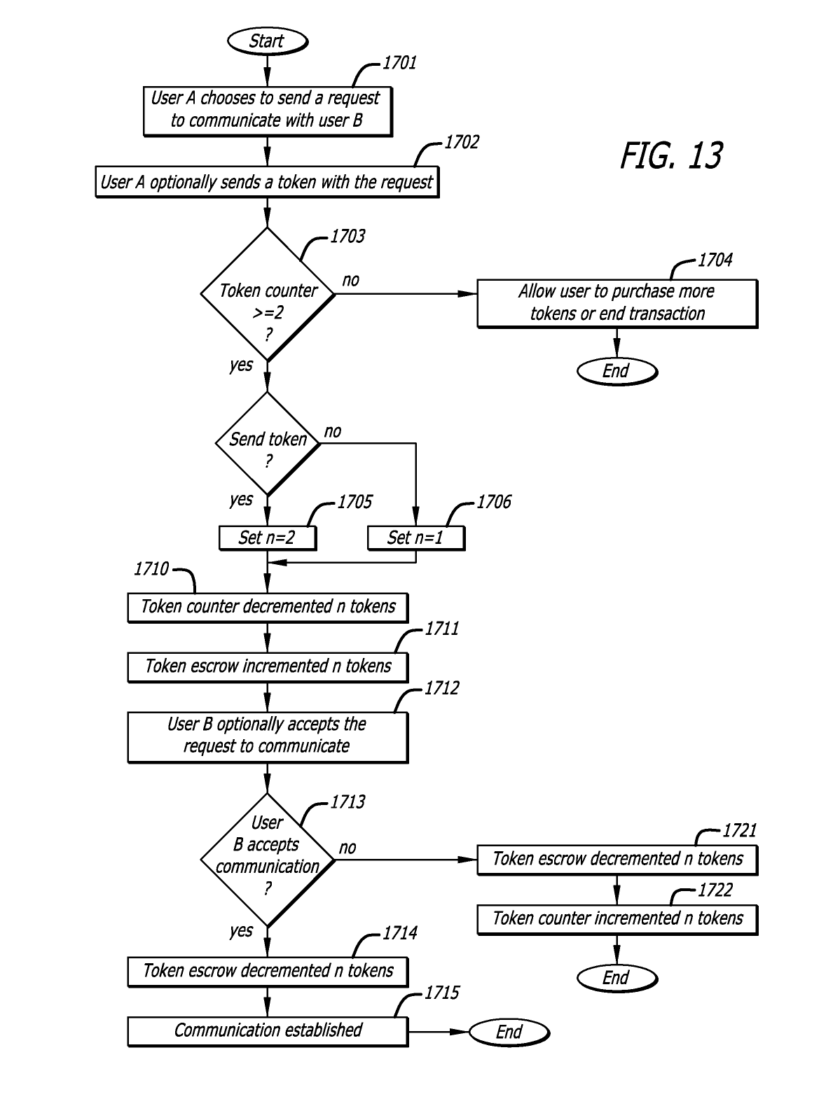

FIG. 13 illustrates sending a token to another user to pay for the receiving user's acceptance. In step 1701, a user sends a request to communicate to another user (assuming that the user has a token to pay for the transaction). In step 1702, the requester optionally sends a token to the receiving user with the request. In step 1703, the system determines whether there are enough tokens in the sending user's account to pay for the receiving user's acceptance. In this embodiment, because the transaction will cost the requester two tokens (one for his request and one for acceptance) token counter 431 should typically have a value of two or higher. If there are not enough tokens to pay for the receiving user's acceptance then, in step 1704, the sending user is allowed to purchase more tokens or end the transaction. Step 1705 and step 1706 illustrate the system setting a number N equal to the number of tokens to be used for the transaction. In step 1705, the system sets N equal to two if the requester has sent a token with the request. In step 1706, the system sets N equal to one if the requester has made a request but has not selected to send a token with the request. In step 1710, token counter 431 is decremented the number of tokens equal to N. In step 1711, token escrow 432 is incremented the same number of tokens. In step 1712, the receiving user optionally accepts the request to communicate and the sent token. Step 1714 and step 1715 illustrate completing the communication connection. In step 1714, the requester's token escrow 432 is decremented N number of tokens. In step 1715, the system establishes the communication.

Step 1721 and step 1722 illustrate the alternative path of a receiving user rejecting a request. The result is that the requester is not charged a token for the request and is not charged for an acceptance. In step 1721 the requester's token escrow 432 is decremented N number of tokens. In step 1722, the requester's token counter 431 is incremented N tokens.

The forgoing description of preferred embodiments of the invention has been presented for the purposes of illustration and description. It is not intended to be exhaustive or to limit the invention to the precise form disclosed. It should be apparent to those of ordinary skill in the art that various adaptations and modifications of the present invention may be accomplished without departing from the spirit and the scope of the invention and are possible in light of the above teaching. It is intended that the scope of the invention not be limited by this detailed description, but by the claims and the equivalents to the claims appended hereto.

I claim:

1. A method of managing multiple communications between a plurality of users in a social network, comprising the steps of:
receiving from a first user a request to initiate a communication exchange with a second user in the social network;
tallying a total number of pending unanswered requests by the first user;
verifying the total number of pending unanswered requests is less than a predetermined number; and
displaying to the second user the request to initiate the communication exchange only if the total number of pending unanswered requests by the first user is less than the predetermined number.

2. The method of claim 1 wherein displaying the request further requires a number of pending unanswered requests by the second user to be less than a second predetermined number.

3. The method of claim 1 further comprising the steps of:
canceling the request if the second user does not answer within a predetermined time; and
allowing the communication exchange if the second user accepts the request within the predetermined time.

4. The method of claim 3 wherein the second user is allowed to answer by postponing the communication exchange with the first user.

5. The method of claim 3 further comprising the step of:
disabling the communication exchange if the first and second users do not communicate within a second predetermined time.

6. The method of claim 1 further comprising the steps of:
storing characteristic data and contact information for each of the plurality of users in the social network,
wherein the contact data includes a true physical address, and
wherein a portion of the characteristic data or contact information may be selectively hidden from a selected subset of all users in the social network, wherein the selected subset of all users includes at least one other user;
receiving criteria data from the first user; and
presenting to the first user non-hidden characteristic data for each user in a subset of the plurality of users, wherein the subset of the plurality of users is determined by the criteria data received from the first user, and wherein the second user is selected from the subset of the plurality of users.

7. The method of claim 6 wherein the subset of the plurality of users is further determined by an availability schedule selected by each of the plurality of users.

8. The method of claim 1 including presenting to the first user characteristic data for each user in a subset of the plurality of users,
wherein the subset of the plurality of users is limited to geographically selected users having a common geographic location with the first user, the common geographic location being determined by a region associated with a specific geographic location of respective GPS-enabled devices, the respective GPS-enabled devices being associated with the first and the geographically selected users, and
wherein the second user is selected from the subset of the plurality of users.

9. The method of claim 8 wherein the region is user-configurable, the region being configurable to a state, city, or radius surrounding the geographic location.

10. The method of claim 8 wherein the predetermined time is set by the first user prior to the subset being determined.

11. The method of claim 3 including storing characteristic data for each of the plurality of users, wherein the characteristic data includes a ratio of total number of accepted requests to a total number of accepted requests in which a communication did not occur within a second predetermined time.

12. The method of claim 3 including storing characteristic data for each of the plurality of users, wherein the characteristic data includes a ratio of total number of requests received to a total number of cancelled requests.

13. The method of claim 1 including:
the first user selecting from a list a selected physical gift to be sent to the second user;
the social network enabling the first user to purchase the selected physical gift;
the second user agreeing to receive the selected physical gift at a true physical address of the second user before the first user is charged a fee and before the gift is purchased or sent to the second user;
the social network forwarding purchase information for the selected physical gift and the true physical address of the second user to a vendor responsible for selling the selected physical gift;
charging an account of the first user; and
sending the gift to the true physical address of the second user.

14. The method of claim 13 wherein the true physical address is not revealed to the first user.

15. The method of claim 1 including:
presenting to the first user characteristic data for each user in a subset of the plurality of users, the subset of the plurality of users being determined by criteria data received from the first user, wherein the second user is selected from the subset of the plurality of users; and
enabling the first user to purchase an advertisement to be displayed as part of the characteristic data of the second user, wherein the advertisement is displayed to the second user when the second user uses the social network.

16. The method of claim 3 further comprises the step of charging the first and second user a first fee when the communication exchange is allowed.

17. The method of claim 16 wherein an amount equal to the first fee is withheld from the first and second user when the request is made and returned if request is cancelled so that the first and second user cannot establish a second communication without paying a second fee until the first fee is returned.

18. The method of claim 16 wherein the first fee is charged only from the first user.

19. The method of claim 16 wherein the first fee is charged only from the second user.

20. The method of claim 16 wherein the first user can pay the first fee for the second user, wherein the second user is notified prior to accepting the communication exchange that the first user will pay for the communication exchange.

21. The method of claim 16 wherein the second user can pay the first fee for the first user, wherein the first user is notified prior to requesting the communication exchange that the second user will pay for the communication exchange.

22. A method of managing multiple communications between a plurality of users in a social network, comprising the steps of:
storing characteristic data and contact information for each of the plurality of users in the social network,
wherein the contact data includes a true physical address, and
wherein a portion of the characteristic data or contact information may be selectively hidden from a selected subset of all users in the social network, wherein the selected subset of all users includes at least one other user;
receiving criteria data from the first user; and
presenting to the first user non-hidden characteristic data for each user in a subset of the plurality of users, wherein the subset of the plurality of users is determined by the criteria data received from the first user, and wherein the second user is selected from the subset of the plurality of users.

23. The method of claim 22 wherein the subset of the plurality of users is further determined by an availability schedule selected by each of the plurality of users.

24. The method of claim 22 wherein the subset of the plurality of users is further limited to geographically selected users having a common geographic location with the first user, the common geographic location being determined by a region associated with a specific geographic location of respective GPS-enabled devices, the respective GPS-enabled devices being associated with the first and geographically selected users.

25. The method of claim 24 wherein the region is user-configurable, the region being configurable to a state, city, or radius surrounding the geo location.

26. The method of claim 24 including:
the first user setting a predetermined time for the second user to answer a request to communicate;
the first user requesting to communicate with the second user.

27. The method of claim 22 including:
the first user selecting from a list a selected physical gift to be sent to the second user;
the social network enabling the first user to purchase the selected physical gift;
the second user agreeing to receive the selected physical gift at the true physical address of the second user before the first user is charged for the gift and before the gift is sent to the second user;
the social network forwarding purchase information for the selected physical gift and the true physical address of the second user to a vendor responsible for selling the selected physical gift;
charging an account of the first user; and
sending the gift to the true physical address of the second user.

28. The method of claim 27 wherein the true physical address is not revealed to the first user.

29. The method of claim 22 further comprises the step of:
enabling the first user to purchase an advertisement to be displayed as part of the characteristic data of the second user, wherein the advertisement is displayed to the second user when the second user uses the social network, and wherein presenting non-hidden characteristic data includes displaying the advertisement.

30. The method of claim 22 further comprises the step of:
displaying to a second user a request to initiate a communication exchange from the first user, wherein the request is displayed only if a number of pending unanswered requests by the first user is less than a predetermined number.

31. The method of claim 30 wherein displaying the request further requires a number of pending unanswered requests by the second user to be less than a second predetermined number.

32. The method of claim 30 further comprising the steps of:
canceling the request if the second user does not answer within a predetermined time; and
allowing the communication exchange if the second user accepts the request within the predetermined time.

33. The method of claim 32 wherein the second user is allowed to answer by postponing communication with the first user.

34. The method of claim 32 further comprising the step of:
disabling the communication exchange if the first and second users do not communicate within a second predetermined time.

35. The method of claim 32 wherein the characteristic data includes a ratio of total number of accepted requests to a total number of accepted requests in which a communication did not occur within a second predetermined time.

36. The method of claim 32 wherein the characteristic data includes a ratio of total number of requests received to a total number of cancelled requests.

37. The method of claim 32 further comprises the step of charging the first and second user a first fee when the communication exchange is allowed.

38. The method of claim 37 wherein an amount equal to the first fee is withheld from the first and second user when the request is made and returned if request is cancelled so that the first and second user cannot establish a second communication without paying a second fee until the first fee is returned.

39. The method of claim 37 wherein the first fee is charged only from the first user.

40. The method of claim 37 wherein the first fee is charged only from the second user.

41. The method of claim 37 wherein the first user can pay the first fee for the second user, wherein the second user is notified prior to accepting the communication exchange that the first user will pay for the communication exchange.

42. The method of claim 37 wherein the second user can pay the first fee for the first user, wherein the first user is notified prior to requesting the communication exchange that the second user will pay for the communication exchange.

43. A computerized system for managing communications between a plurality of users in a social network, comprising:
a database that stores at least a unique identifier for each of the plurality of users; and
a server computer,
wherein the server is programmed to receive from the first user a request to initiate a communication exchange with the second user, and
wherein the server is programmed to forward the request to the second user, and
wherein the server has a programmable setting for restricting a maximum number of pending unanswered requests by a user, and
wherein the server has a programmable setting for canceling the request if the second user does not reply within a predetermined time.

44. The system of claim 43 wherein the server is programmed to allow a communication exchange between the first user and the second user if the second user accepts the request.

45. The method of claim 43 wherein the second user is allowed to reply by postponing communication with the first user.

46. The system of claim 44 wherein the server is programmed to store connection information when the second user replies to the request, the connection information being at least the unique identifier of the first user and the unique identifier of the second user.

47. The system of claim 43 wherein the server has a programmable setting for disabling the communication exchange if the second user does not communicate with the first user within a second predetermined time.

48. The system of claim 43 wherein the server is programmed to store in the database an availability schedule for each of the plurality of users.

49. The system of claim 48 wherein the server is programmed to limit communications between any of the plurality of users and at least one other user by the availability schedule.

50. The system of claim 43 wherein the server is programmed to receive characteristic data and contact information from at least one of the plurality of users, and
wherein the server is programmed to receive criteria data from a first user, and
wherein the server is programmed to allow the plurality of users to selectively hide a portion of the characteristic data or contact information from a selected subset of all users in the social network, wherein the selected subset of all users includes at least one other user, and
wherein the server is programmed to present to the first user non-hidden characteristic data for each user in a subset of the plurality of users, the subset of the plurality of users being determined by the criteria data received from the first user, wherein the second user is selected from the subset of the plurality of users.

51. The system of claim 43 wherein the server is programmed to limit communications in the social network to users in a common geographic location, the common location region being determined by a region associated with a specific geographic location of respective GPS-enabled devices, the respective GPS-enabled devices being associated with the users.

52. The system of claim 51 wherein the region is user-configurable, the region being configurable to a state, city, or radius surrounding the specific geographic location.

53. The system of claim 51 wherein the predetermined time is set by the second user prior to the request being made by the first user.

54. The system of claim 43 wherein the server is programmed to:
display a list of physical gifts to the first user, and
enable the first user select from the list a selected physical gift to be sent to the second user, and
enable the first user to initiate a purchase of the selected physical gift, and
enable the second user to accept to receive the selected physical gift at a true physical address of the second user before the first user is charged a fee and before the gift is purchased or sent to the second user, and
after the second user has selected the gift, send purchase information for the selected physical gift and the true physical address of the second user to a vendor responsible for selling the selected physical gift.

55. The system of claim 44 wherein the server is programmed to charge the first and second user a first fee when the communication exchange is allowed.

56. The system of claim 55 wherein an amount equal to the first fee is withheld from the first and second user when the request is made and returned if request is cancelled so that the first and second user cannot establish a second communication without paying a second fee until the first fee is returned.

57. The system of claim 55 wherein the first fee is charged only from the first user.

58. The system of claim 55 wherein the first fee is charged only from the second user.

59. The system of claim 43 wherein the server is programmed to display a ratio of total number of requests received to a total number of cancelled requests.

60. The system of claim 44 wherein the server is programmed to display a ratio of total number of accepted requests to a total number of accepted requests in which a communication did not occur within a second predetermined time.

61. A method of generating revenue from a plurality of users in an online social network the improvement comprising the steps of:
establishing a communication exchange between a first and a second user when the second user accepts a request to initiate the communication exchange by the first user, and
charging the first and second user a first fee for each communication exchange.

62. The method of claim 61 wherein an amount equal to the first fee is withheld from the first and second user when the request is made and returned if the request is not accepted within a predetermined time so that the first and second user cannot establish a second communication exchange without paying a second fee until the first fee is returned.

63. The method of claim 61 wherein the first fee is charged only from the first user.

64. The method of claim 61 wherein the first fee is charged only from the second user.

65. The method of claim 61 wherein the first fee comprises at least one token, wherein a user can purchase a number of tokens for a third fee.

66. The method of claim 62 wherein the second fee comprises at least one token, wherein a user can purchase a number of tokens for a third fee.

67. The method of claim 61 wherein the first user can pay the first fee for the second user, and wherein the second user is notified prior to accepting the communication exchange that the first user will pay for the communication exchange.

68. The method of claim 61 wherein the second user can pay the first fee for the first user, and wherein the first user is notified prior to requesting the communication exchange that the second user will pay for the communication exchange.

69. The method of claim 61 wherein the first user selects a membership level prior to the second user accepting the request to initiate the communication exchange, and wherein
the first fee is increased proportional to the selected membership level.

70. The method of claim 61 wherein the second user selects a membership level prior to the request to initiate the communication exchange, and wherein the first fee is increased proportional to the selected membership level.

71. The method of claim 61 wherein the first fee is increased proportional to a selected membership level, the selected membership level being selected from the highest of a first membership level selected by the first user and a second membership level selected by the second user, and wherein the first and second membership levels are selected prior to establishing the communication exchange.

72. A method of managing multiple communications between a plurality of users in a social network, comprising the steps of:
a first user selecting a first membership level, wherein a first communication fee is associated with the first membership level;
a second user selecting a second membership level, wherein a second communication fee is associated with the second membership level;
receiving from the first user a request to initiate a communication exchange with the second user in the social network; and
selecting a selected fee, wherein the selected fee is the highest of the first and second communication fees, and wherein the selected fee is set as the cost of a completed communication exchange.

73. The method of claim 72 further comprising the steps of:
tallying a total amount of selected fees for pending unanswered requests by the first user;
verifying the total amount of selected fees is less than an amount in an account of the first user; and
displaying to the second user the request to initiate the communication exchange only if the total amount of selected fees for pending unanswered requests by the first user is less than the amount in the account of the first user.

74. The method of claim 73 wherein displaying the request further requires a total amount of selected fees for unanswered requests by the second user to be less than an amount in an account of the second user.

75. The method of claim 73 further comprising the steps of:
canceling the request if the second user does not answer within a predetermined time; and
allowing the communication exchange if the second user accepts the request within the predetermined time.

76. The method of claim 75 further comprises the step of charging the first and second user the selected fee when the communication exchange is allowed.

77. The method of claim 76 wherein an amount equal to the selected fee is withheld from the first and second user when the request is made and returned if request is cancelled.
